(19) United States
(12) Patent Application Publication
(10) Pub. No.: US 2006/0204814 A1
(43) Pub. Date: Sep. 14, 2006

(54) Fuel supply unit for fuel cell and fuel cell using same

(76) Inventors: Shoji Sekino, Tokyo (JP); Takeshi Obata, Tokyo (JP); Shin Nakamura, Tokyo (JP); Yoshimi Kubo, Tokyo (JP)

Correspondence Address: HAYES, SOLOWAY P.C., 3450 E. SUNRISE DRIVE, SUITE 140, TUCSON, AZ, 85718, US

(21) Appl. No.: 10/567,326

(22) PCT Filed: Aug. 23, 2004
(86) PCT No.: PCT/JP04/12071

§ 371 Date: Feb. 7, 2006

(30) Foreign Application Priority Data
Aug. 22, 2003 (JP) 2003-298260

(51) Int. Cl. H01M 8/04; B65D 90/02

(52) U.S. Cl. 429/34; 220/565

(57) ABSTRACT

A fuel cell (723) includes, a high-concentration fuel vessel (715) placed adjacent to a fuel vessel (713) that supplies a fuel (124) to a unit cell structure (101), and a permeation control film (717) that is placed at the boundary between the fuel vessel (713) and the high-concentration fuel vessel (715) and controls the transmission of a high-concentration fuel (725) in the fuel (124).

### TECHNICAL FIELD

The invention relates to fuel suppliers for use in fuel cells and to fuel cells using thereof.

### BACKGROUND ART

The advent of information-oriented society in recent years has provided a dramatic increase in the amount of information to be processed in electronic devices such as personal computers, with which power consumption of electronic devices has significantly increased. In particular, portable electronic devices have a problem of an increase in power consumption associated with an increase in throughput. At present, such portable electronic devices generally use lithium ion batteries as a power source, but the energy density of the lithium ion batteries is reaching the theoretical limit. Thus, in order to extend the time period of continuous operation time of portable electronic devices, it has been necessary to suppress the CPU drive frequency in line and to reduce the power consumption.

In such situations, it is expected that high-energy-density, high-heat-exchanger-effectiveness fuel cells can be used in place of lithium ion batteries as a power source for electronic devices so that the time period of continuous operation of portable electronic devices can significantly be increased.

Fuel cells are composed of a fuel electrode and an oxidant electrode (hereinafter these electrodes are also referred to as “catalyst electrode”) and a Electrolyte placed therebetween, in which a fuel and an oxidizer are supplied to the fuel electrode and the oxidant electrode, respectively, when electricity is produced by electrochemical reaction. While hydrogen is generally used as the fuel, recent years have seen active development of methanol fuel cells such as methanol reforming types that use methanol as a starting material and reform it into hydrogen and direct types that directly use methanol as a fuel.

Where hydrogen is used as a fuel, the reaction occurred at the fuel electrode is represented by the following formula (1).
3H₂→6H⁺+6e⁻ (1)

Where methanol is used as a fuel, the reaction occurred at the fuel electrode is represented by the following formula (2).
CH₃OH+H₂O→6H⁺+CO₂+6e⁻ (2)

In both cases, the reaction occurred at the oxidant electrode is represented by the following formula (3).
3/2O₂+6H⁺+6e⁻→3H₂O (3)

In particular, the direct type fuel cells can produce hydrogen ions from an aqueous methanol solution and thus need no reformer or the like and can be advantageously applied to potable electronic devices. The direct type fuel cells are also characterized in that the energy density is very high because such a liquid fuel as an aqueous methanol solution which is a liquid is used as fuel.

In view of long term service, such liquid-fuel supply type fuel cells preferably use high concentrations of fuel components in the liquid supplied to the fuel electrode.

If liquid organic fuels with a high affinity for water, such as methanol, is used, however, crossover can easily occur in which the fuel component at higher concentrations diffuse into the water-containing solid electrolyte membrane and reaches the oxidant electrode. Although the liquid organic fuel should necessarily supply electrons at the fuel electrode, the liquid organic fuel is oxidized at the oxidant electrode side due to the crossover so that a reduction in voltage, output or fuel efficiency can occur because it is not efficiently used as a fuel. Thus, it is difficult to increase the fuel component concentration of the liquid being supplied to the fuel electrode.

There is proposed a technique for increasing the volume energy efficiency of a fuel cell system at a fuel concentration where the crossover-induced reduction in output characteristics is made small (see Patent Literature 1). Patent Literature 1 discloses a fuel cell in which high-concentration methanol is connected through a valve to a fuel tank that stores an aqueous methanol solution as a fuel. The valve is controlled by means of a controller such that the supply of the high-concentration methanol from a high-concentration methanol tank to the fuel tank is controlled. Patent Literature 1 discloses that the installation of the high-concentration methanol tank allows an improvement in the volume energy efficiency of the fuel cell.

However, the structure disclosed in Patent Literature 1 needs to have a large feedback control mechanism, because the supply of the high-concentration methanol from the high-concentration methanol tank to the fuel tank is controlled by valve operation. Thus, the whole of the fuel cell is large and complicated and still has room for improvement in view of space saving and lightweight. Particularly, there has been a demand for more compact and simple mechanisms for the applications to portable devices such as portable personal computers or cellular phones.

[Patent Literature 1]: Japanese Laid-Open patent publication No. 2003-132924

### DISCLOSURE OF INVENTION

The invention has been made in view of the above circumstances, and it is an object of the invention to provide technology for operating liquid-fuel supply type fuel cells stably for an extended period of time. It is another object of the invention to provide technology for downsizing liquid-fuel supply type fuel cells.

According to the invention, there is provided a fuel supplier placed in a fuel supply system of a fuel cell, including: a fuel vessel; and a permeation control film through which a supplementary fuel contained in the fuel vessel is restrictively transmitted and transferred to the fuel supply system.

The fuel supplier of the invention allows restrictive transfer of the supplementary fuel through the permeation control film to the fuel supply system with high controllability. Thus, the supplementary fuel can be supplied through the permeation control film, when the fuel in the fuel supply system is decreased by the operation of the fuel cell. The fuel cell can be stably operated for an extended period of time with a simple structure.

In the fuel supplier of the invention, the permeation control film may restrict the amount of transmission of the supplementary fuel based on the fuel concentration of a liquid fuel in the fuel supply system. This feature allows sophisticated control of the amount of transmission depending on variations in the concentration of the liquid fuel in the fuel supply system. Thus, while the concentration of the fuel in the fuel supply system is maintained at a certain concentration where crossover is prevented, the liquid fuel decreased by the operation of the fuel cell can be supplemented with the fuel from the fuel vessel, so that the liquid fuel concentration in the fuel supply system can be controlled to a predetermined concentration. The fuel component concentration of the supplementary fuel may be higher than that of the liquid fuel. Thus, the gradient of the fuel component concentration between liquid in the fuel supplier and liquid fuel in the fuel supply system can be used for the supply of the supplementary fuel to the fuel supply system so that the reduction in the concentration of the fuel component in the fuel supply system can be suppressed.

In the fuel supplier of the invention, the permeation control film may change its shape depending on the concentration of the liquid fuel such that the amount of transmission of the supplementary fuel is changed. This feature allows control of transfer of the supplementary fuel with a spontaneous morphological change of the permeation control film depending on the liquid fuel concentration. Thus, the amount of transmission of the supplementary fuel can be controlled with a simple structure having no control unit or the like for measuring the liquid fuel concentration in the fuel supply system and controlling the amount of transmission of the supplemental fuel. Thus, the fuel cell can be made compact or lightweight. The device configuration of the fuel cell can also be simplified.

In the fuel supplier of the invention, the film may shrink and expand depending on the concentration of the liquid fuel so as to change its open area ratio. This feature allows control of the amount of transmission of the supplementary fuel.

In the fuel supplier of the invention, the permeation control film may include a fuel permeable film that transmits the supplementary fuel and a shutter member that is placed on the fuel permeable film and controls an exposed area of the fuel permeable film. In such a structure, the supplementary fuel is allowed to move from the exposed portion of the fuel permeable film to the fuel supply system. The shutter member placed on the fuel permeable film allows adjustment of the exposed area of the fuel permeable film, so that the amount of transmission of the supplementary fuel can be controlled.

In the fuel supplier of the invention, the shutter member may be configured to restrict the amount of transmission of the supplementary fuel based on the fuel concentration of the liquid fuel in the fuel supply system. This feature allows control of the supply of the supplementary fuel in such a manner that the concentration of the fuel in the fuel supply system can be maintained at a desired concentration. Thus, while crossover is suppressed in the fuel cell, a high level output can be produced stably.

The fuel supplier of the invention may be configured such that the exposed area of the fuel permeable film is changed stepwise depending on the concentration of the liquid fuel in the fuel supply system. This feature allows more precise control of the amount of supply of the supplementary fuel.

In the fuel supplier of the invention, the shutter member may include an elastic film having a cut portion, and a surface of the elastic film is allowed to expand and contract such that the cut portion changes its shape and that the exposed area of the fuel permeable film is controlled. This feature allows easy control of the opening area of the cut portion provided on the fuel permeable film by expansion or contraction of the shutter member. Thus, the exposed area of the fuel permeable film can be controlled with a simple structure.

The fuel supplier of the invention may be configured to further include a shutter control member that allows the shutter member to slide on the surface of the fuel permeable film such that the exposed area of the fuel permeable film is controlled. In the structure with the shutter member slidably provided on the surface of the fuel permeable film, the degree of shielding of the surface of the fuel permeable film can be controlled with the shutter member. This feature allows control of the exposed area of the fuel permeable film and thus allows control of the amount of supply of the supplementary fuel through the fuel permeable film. In the fuel supplier of the invention, the shutter member may also have an opening. In such a structure, the shutter member can be allowed to slide on the surface of the fuel permeable film such that the exposed area of the fuel permeable film can be changed stepwise. Thus, the concentration of the fuel in the fuel supply system can be more precisely controlled.

In the fuel supplier of the invention, the fuel permeable film may be configured so as to restrict the amount of transmission of the liquid fuel based on the fuel concentration of the liquid fuel in the fuel supply system. This feature provides additional controllability for the transmission of the supplementary fuel to the fuel permeable film itself. Thus, the fuel permeable film and the shutter member may be used in combination such that the amount of transmission of the supplementary fuel can be restricted.

The fuel supplier of the invention may further include a fuel supply unit that is placed adjacent to the fuel vessel through the permeation control film and configured so as to change its volume depending on its internal pressure. This feature can suppress an increase in the internal pressure of the fuel supply system due to carbon dioxide and the like produced with the operation of the liquid-fuel supply type fuel cell. Thus, the supplementary fuel is allowed to move from the fuel supplier toward the fuel supply system, so that methanol at a concentration for most efficient generation of electricity can be stably supplied. The arrangement of the fuel supply unit and the fuel supply system adjacent to each other allows downsizing and weight saving of the overall fuel cell.

According to the invention, there is provided a fuel cell, including: a solid electrolyte membrane; a fuel electrode and an oxidant electrode placed on the solid electrolyte membrane; and a fuel supply system that supplies a fuel to the fuel electrode, wherein said fuel supply system has said fuel supplier.

The fuel cell according to the invention has the above fuel supplier and thus can supply the supplementary fuel through the permeation control film when the concentration of the liquid fuel in the fuel supply system is decreased by the operation. Thus, the concentration of the liquid fuel can be maintained at a desired concentration by means of a simple system configuration. Accordingly, while the concentration of the fuel in the fuel supply system is maintained at a certain concentration where crossover does not occur, a high level output can be stably produced for an extended period of time.

The fuel cell of the invention may further include a gas duct through which a gas produced at the fuel electrode is guided to the fuel vessel.

Any combinations of the above constituent and substitutions of the constituent or wording of the invention between the components or elements of the invention or substitutions between the methods and the devices are effectively possible according to embodiments of the invention.

For example, the fuel supplier of the invention may be detachable in the fuel cell, so that the fuel supplier can be easily replaced by another fuel supplier after the supplementary fuel in the fuel vessel is consumed. Thus, the fuel cell can be operated for a further extended period of time with a simple structure. The fuel supply system containing the fuel supplier may also be detachable.

According to the invention, there can be provided technology of operating liquid-fuel supply type fuel cells stably for an extended period of time. According to the invention, liquid-fuel supply type fuel cells can also be made compact.

### BRIEF DESCRIPTION OF THE DRAWINGS

The above and other objects, features and advantages will become more apparent from the preferred embodiments below, taken in conjunction with the accompanying drawings:

FIG. 1 is a cross-sectional view schematically showing the structure of a fuel cell according to an embodiment;

FIG. 2 is a cross-sectional view of the fuel cell along line A-A′ of FIG. 1;

FIG. 3 is a cross-sectional view of the fuel cell along line A-A′ of FIG. 1;

FIG. 4 is a cross-sectional view schematically showing the structure of a unit cell of the fuel cell in FIG. 1;

FIG. 5 is a cross-sectional view schematically showing the structure of a fuel cell according to an embodiment;

FIG. 6 is a cross-sectional view schematically showing the structure of a fuel cell according to an embodiment;

FIG. 7 is a cross-sectional view showing the structure of a permeation control film of a fuel cell according to an embodiment;

FIG. 8 is a cross-sectional view showing the structure of a permeation control film of a fuel cell according to an embodiment;

FIG. 9 is a cross-sectional view showing the structure of a permeation control film of a fuel cell according to an embodiment;

FIG. 10 is a cross-sectional view showing the structure of a permeation control film of a fuel cell according to an embodiment;

FIG. 11 is a cross-sectional view showing the structure of a permeation control film of a fuel cell according to an embodiment;

FIG. 12 is a cross-sectional view showing the structure of a permeation control film of a fuel cell according to an embodiment;

FIG. 13 is a cross-sectional view showing the structure of a permeation control film of a fuel cell according to an embodiment;

FIG. 14 is a cross-sectional view showing the structure of a permeation control film of a fuel cell according to an embodiment;

FIG. 15 is a cross-sectional view showing the structure of a permeation control film of a fuel cell according to an embodiment;

FIG. 16 is a cross-sectional view of the permeation control film along line B-B′ of FIG. 15;

FIG. 17 is a cross-sectional view showing the structure of a permeation control film of a fuel cell according to an embodiment;

FIG. 18 is a cross-sectional view of the permeation control film along ling B-B′ of FIG. 17;

FIG. 19 is a cross-sectional view of the permeation control film along line B-B′ of FIG. 17;

FIG. 20 is a cross-sectional view showing the structure of a permeation control film of a fuel cell according to an embodiment;

FIG. 21 is a cross-sectional view showing the structure of a permeation control film of a fuel cell according to an embodiment;

FIG. 22 is a cross-sectional view showing the structure of a permeation control film of a fuel cell according to an embodiment;

FIG. 23 is a cross-sectional view showing the structure of a fuel cell system according to an embodiment;

FIG. 24 is a diagram showing the structure of a sensor of the fuel cell system in FIG. 23;

FIG. 25 is a diagram showing the structure of a concentration-measuring unit of the fuel cell system in FIG. 23;

FIG. 26 is a cross-sectional view showing the structure of a fuel cell according to an embodiment;

FIG. 27 is a cross-sectional view showing the structure of a fuel cell according to an embodiment; and

FIG. 28 is a graph showing the relationship between elapsed time of operation of a fuel cell of an example and cell voltage.

### BEST MODE FOR CARRYING OUT THE INVENTION

Some embodiments of the invention are described blow with reference to the drawings. In the drawings, the same reference numerals are designated to the common constituent, and the explanation is not appropriately described.

The fuel cells described in the embodiments below can be appropriately used in any applications, examples of which include, but are not limited to, small-sized electrical devices such as cellular phones, portable personal computers such as notebook computers, PDAs (Personal Digital Assistants), a variety of cameras, navigation systems, portable music players and the like.

### FIRST EMBODIMENT

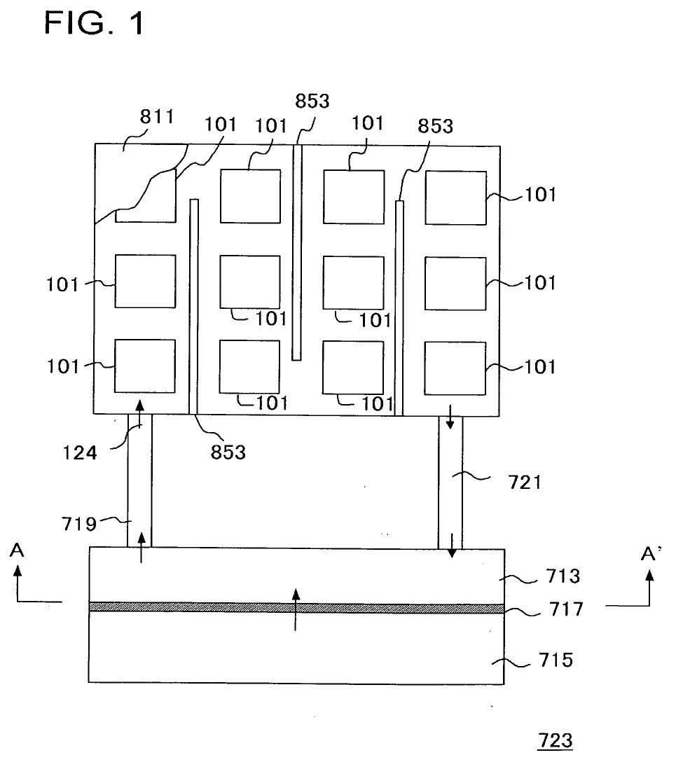

FIG. 1 is a plan view schematically showing the structure of a fuel cell in this embodiment.

Referring to FIG. 1, a fuel cell 723 includes a plurality of unit cell structures 101, a fuel vessel 713 placed for the plurality of unit cell structures 101, a high-concentration fuel vessel 715 that supplies a high-concentration fuel 725 to the fuel vessel 713, and a permeation control film 717 placed between the fuel vessel 713 and the high-concentration fuel vessel 715.

A fuel vessel 811 is placed in contact with a fuel electrode 102. A fuel 124 contained in the fuel vessel 811 is supplied to the fuel electrode 102. The fuel vessel 811 is connected to the fuel vessel 713 through fuel passages 719 and 721.

The fuel 124 is supplied to the fuel vessel 811 through the fuel passage 719. The fuel are allowed to flow along a plurality of partition plates 853 provided in the fuel vessel 811 and sequentially supplied to the plurality of unit cell structures 101. The fuel is circulated in a plurality of the unit cell structures 101 and then collected into the fuel vessel 713 through the fuel passage 721. The configuration of the unit cell structure 101 is described in detail later.

In this embodiment and other embodiments below, the fuel 124 refers to a liquid fuel to be supplied to the unit cell structure 101 and includes an organic solvent as a fuel component and water. The fuel component contained in the fuel 124 may be a liquid organic fuel such as methanol, ethanol, dimethyl ether, other alcohols, and liquid hydrocarbons like cycloparaffin or the like. A description is given below of a case wherein the fuel component is methanol. While air may generally be used as an oxidizer, oxygen gas may also be supplied.

In the fuel cell 723, the high-concentration fuel vessel 715 is adjacent to the fuel vessel 713 through the permeation control film 717. The permeation control film 717 controls the transmission of the high-concentration fuel 725 from the high-concentration fuel vessel 715 to the fuel vessel 713.

The fuel vessel 713 contains the fuel 124 which has such a fuel component concentration as to be supplied to the unit cell structures 101. The high-concentration fuel 725 having a fuel component concentration not lower than that of the fuel 124 is contained in the high-concentration fuel vessel 715. If the fuel component is methanol, for example, the fuel vessel 713 may contain water or an aqueous solution of about 50% by volume or less of methanol. In this case, the high-concentration fuel vessel 715 may contain methanol or an aqueous solution of methanol at a concentration not lower than that of the fuel 124.

In the operation of the fuel cell 723, the fuel 124 is consumed from the fuel vessel 713, and a liquid having a fuel component concentration lower than that of the fuel 124 is recovered through the fuel passage 721. As the fuel cell 723 is operated, therefore, the fuel component concentration of the liquid in the fuel vessel 713 is reduced to significantly differ from that of the liquid in the high-concentration fuel vessel 715.

The permeation control film 717 is structured so as to change its permeability to the fuel component depending on the fuel component concentration of the liquid in the fuel vessel 713. Such a structure may use, for the permeation control film 717, the film having sensitivity to the concentration of the fuel component. For example, such film may be a film that changes its form or morphology depending on the fuel component concentration so as to change its open area ratio. Alternatively, the permeation control film 717 may use a combination of a fuel permeable film having permeability to the fuel component and a shutter that is covered with a fuel permeable film controls the exposed area of the fuel permeable film.

This embodiment is described with reference to the case of using a film that changes its open area ratio by itself depending on the fuel component concentration. The fuel vessel 713 and the high-concentration fuel vessel 715 separated by the permeation control film 717 achieve a structure in which the high-concentration fuel 725 is allowed to move from the high-concentration fuel vessel 715 to the fuel vessel 713 through the permeation control film 717 depending on the fuel component concentration gradient.

In such a structure, the high-concentration fuel 725 is gradually supplied from the high-concentration fuel vessel 715 to the fuel vessel 713 so that the concentration of the fuel component in the fuel vessel 713 can be maintained suitable for the electric generation in the unit cell structures 101. The fuel component concentration of the fuel 124 can also be suppressed from being reduced, while kept at such a low level that crossover does not occur. Thus, high cell voltages can be stably obtained. Since the high-concentration fuel vessel 715 contains the high-concentration fuel 725, the whole of the fuel cell 723 can have improved volume energy efficiency.

The permeation control film 717 and the high-concentration fuel vessel 715 may be integrated into a member that is configured so as to be detachable from the main body of the fuel cell including the unit cell structures 101. For example, such a component may be a cartridge-type fuel supply device. Alternatively, the fuel vessel 713, the permeation control film 717 and the high-concentration fuel vessel 715 may be integrated into a component that is configured so as to be detachable from the main body of the fuel cell including the unit cell structures 101.

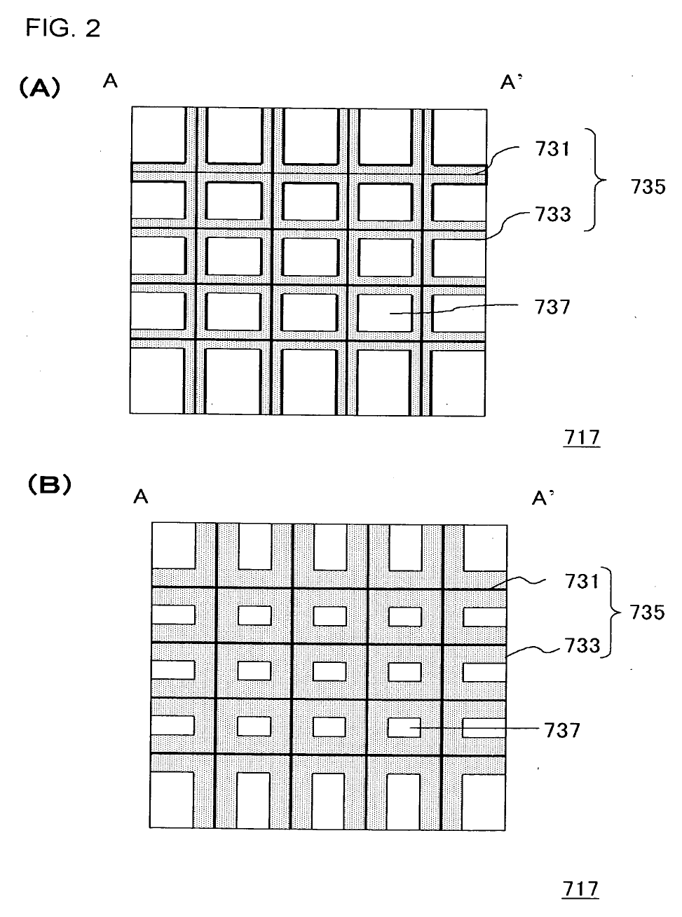

Some specific structures for the permeation control film 717 are described below. FIGS. 2A and 2B are cross-sectional views along line A-A′ of FIG. 1 and also top views schematically showing the structure of the permeation control film 717. FIG. 2A shows a permeation control film 735 in a low-fuel-component-concentration state, while FIG. 2B shows the permeation control film 735 in a high-fuel-component-concentration state.

In FIG. 2, the permeation control film 717 is composed of the permeation control film 735, which includes a supporting member 731 and a polymer 733 and changes the size of the pores 737 depending on the fuel component concentration so as to control the transmission of the high-concentration fuel 725.

The support 731 may be a porous film capable of supporting the polymer 733 and preferably uses materials having good corrosion resistance to the fuel component. For example, the supporting member may be a metal mesh, a porous metal sheet, or a foamable metal material. The porous metal sheet may be of any type that has holes through both sides so as to transmit the high-concentration fuel 725 and may have any shape or thickness. For example, a porous thin metal plate may be used, and a metal fiber sheet may also be used. The metal fiber sheets may be any material having one or more metal fibers shaped into a sheet, and an unwoven or woven sheet of metal fibers may be used. The supporting member 731 may also be made of any material other than metal, such as polymers, ceramics or glass. Specifically, a chemical fiber sheet or a glass fiber sheet may also be used.

The polymer 733 may be made of a polymer material that swells in response to an increase in the fuel component concentration. For example, the materials as described later applicable to a solid electrolyte membrane for the unit cell structure 101 may be used. Specifically, sulfone group-containing perfluorocarbons (Nafion (registered trademark) manufactured by Du Pont K.K.) may be used. Hydrocarbon- or polyimide-based films that shrink and expand depending on the fuel component concentration may also be used.

For example, where the fuel component is methanol, such a material shrinks as the methanol concentration decreases. Thus, when the methanol concentration in the fuel vessel 713 is reduced by the operation of the fuel cell 723, the size of the pores 737 is increased so that the open area ratio is increased. Consequently, more methanol is transmitted from the high-concentration fuel vessel 715 to the fuel vessel 713. Using such a permeation control film 735 as the film 717, the reduction in the methanol concentration in the fuel vessel 713 can be suppressed using differences in the methanol transmission rate of the permeation control film 717. Thus, the methanol concentration of the fuel 124 can be kept constant, and the fuel 124 at suitable concentrations can be stably supplied to the unit cell structures 101 for an extended period of time. Thus, the fuel cell 723 can be stably operated for an extended period of time.

The use of the permeation control film 735 avoids the necessity for using outer power or outer electric power for controlling the permeation control film 717, and thus the whole of the fuel cell 723 can be made compact and lightweight.

For example, the permeation control film 735 may be prepared by a process including immersing the supporting member 731 in a liquid containing the polymer 733 and drying it. Alternatively, the film 735 may be prepared by spray coating with the liquid or adding the liquid dropwise to a film surface or the like. The film 735 may also be prepared using conventional methods for producing polymer films such as graft polymerization of a monomer on the surface of the supporting member 731.

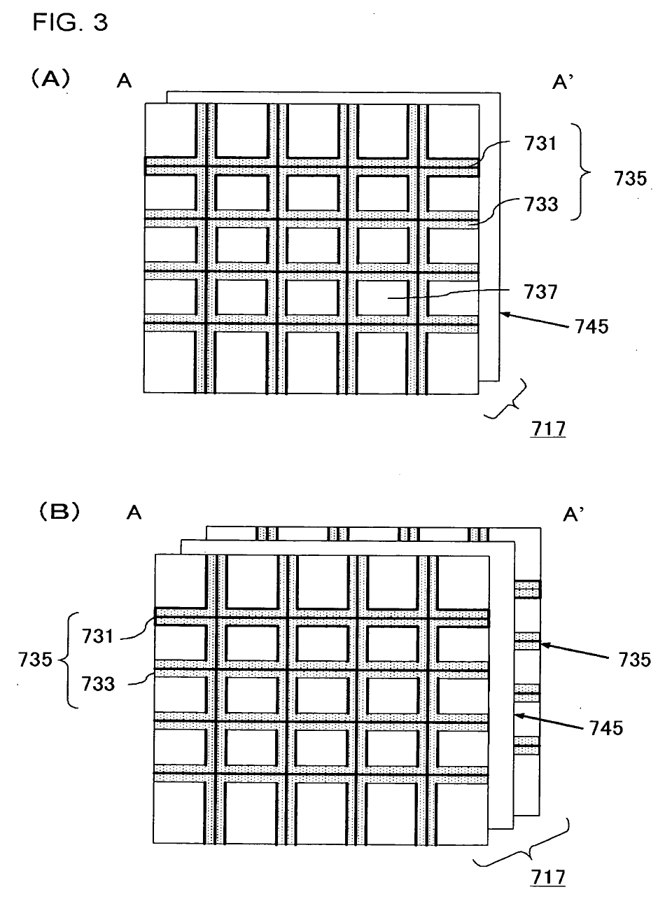

FIGS. 3A and 3B are diagrams each showing another configuration of the permeation control film 717. FIG. 3A shows a configuration e including the permeation control film 735 attached to one side of a fuel permeable film 745, while FIG. 3B shows a structure including the permeation control films 735 attached to both sides of a fuel permeable film 745.

The fuel permeable film 745 is permeable to the fuel component of the fuel 124. In the structure having the fuel permeable film 745 attached to the permeation control film 735, the film 735 serves as a shutter capable of changing the exposed area of the film 745. Thus, the exposed area of the fuel permeable film 745 is so adjusted that the permeability to the high-concentration fuel 725 can be more precisely controlled.

In the structure of the permeation control film 717 as shown in FIG. 3A or 3B, the fuel permeable film 745 may use the materials as described later in the fourth embodiment or the like.

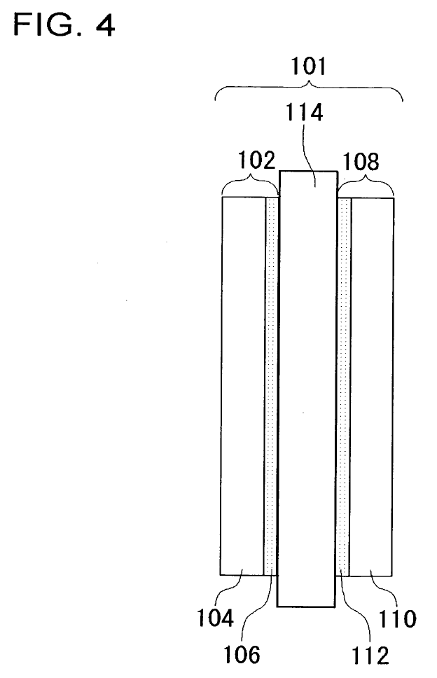

The configuration of the unit cell structure 101 as shown in FIG. 1 is described below with reference to FIG. 4. FIG. 4 is a cross-sectional view schematically showing the unit cell structure 101. Each unit cell structure 101 includes a fuel electrode 102, an oxidant electrode 108 and a solid electrolyte membrane 114.

The solid electrolyte membrane 114 has the functions of separating the fuel electrode 102 and the oxidant electrode 108 and of allowing hydrogen ions to move between them. Therefore, the solid electrolyte membrane 114 preferably has high hydrogen-ion conductivity. In a preferred mode, the membrane 114 is also chemically stable and has high mechanical strength.

The material for the solid electrolyte membrane 114 is preferably an organic polymer having a polar group such as a strong acid group such as a sulfone group, a phosphate group, a phosphonic group and a phosphinic group; and a weak acid group such as a carboxyl group. Examples of such an organic polymer include aromatic-containing polymers such as sulfonated poly(4-phenoxybenzoyl-1,4-phenylene) or alkylsulfonated polybenzimidazole; copolymers such as polystyrenesulfonic acid copolymers, polyvinylsulfonic acid copolymers and fluorine-containing polymers composed of a crosslinked alkylsulfonic acid derivative, a fluororesin skeleton and sulfonic acid; copolymers produced by copolymerizing acrylamides such as acrylamide-2-methylpropanesulfonic acid with acrylates such as n-butyl methacrylate; sulfone group-containing perfluorocarbons (Nafion (registered trademark: manufactured by Du Pont K.K.), Aciplex (registered trademark: manufactured by Asahi Kasei Corporation.); and carboxyl-containing perfluorocarbons (Flemion S films, manufactured by ASAHI GLASS CO., LTD). If the aromatic-containing polymer such as sulfonated poly(4-phenoxybenzoyl-1,4-phenylene), alkylsulfonated polybenzimidazole and the like is selected from these polymers, the transmission of liquid organic fuels can be controlled, and a crossover-induced reduction in cell efficiency can be suppressed.

The fuel electrode 102 and the oxidant electrode 108 includes a fuel electrode-side catalyst layer 106 and an oxidant electrode-side catalyst layer 112, respectively, each of which includes catalyst-carrying carbon particles and fine particles of a solid Electrolyte and is formed on a substrate 104 or 110. Examples of the catalyst include platinum and alloys of platinum and ruthenium and the like. The fuel electrode 102 and the oxidant electrode 108 may use the same or different catalysts.

The substrates 104 and 110 may be made of the materials as described later in the third embodiment. The surface of these substrates may be water repellent finished. When methanol is used as the fuel 124 as mentioned above, carbon dioxide is produced at the fuel electrode 102. If bubbles of carbon dioxide produced at the fuel electrode 102 stays around the fuel electrode 102, the supply of the fuel 124 to the fuel electrode 102 can be inhibited, which can be a cause of a reduction in electric generation efficiency. Thus, the substrate 104 is preferably surface-treated with a hydrophilic or hydrophobic coating material. The surface of the substrate 104 surface-treated with the hydrophilic coating material provides enhanced fluidity of the fuel so that bubbles of carbon dioxide can easily move together with the fuel 124. If the surface of the substrate 104 is treated with the hydrophobic coating material, deposition of water on the surface of the substrate 104, which would otherwise be a cause of generation of bubbles, can be reduced.

Thus, the generation of bubbles on the surface of the substrate 104 can be reduced. A synergistic effect of the surface treatment and the process of vibrating the main body 100 of the fuel cell allows more efficient removal of carbon dioxide from the fuel electrode 102 and thus achieves high electric generation efficiency. Examples of the hydrophilic coating material include titanium oxide and silicon oxide and the like. Examples of the hydrophobic coating material include polytetrafluoroethylene and silane and the like.

The unit cell structures 101 each configured as described above may be arranged as shown in FIG. 1 to obtain the fuel cell 723 having a plurality of the unit cell structures 101 connected in series. Alternatively, the unit cell structures 101 may be stacked to obtain a fuel cell including a fuel cell stack.

According to this embodiment, the high-concentration fuel 725 of the high-concentration fuels stored in the high-concentration fuel vessel 715 is supplied through the permeation control film 717 to the fuel vessel 713 so that the supply of the fuel component to the fuel vessel 713 controlled and that the concentration of the fuel component in the fuel 124 can be can be controlled to a predetermined concentration. Thus, the concentration of the fuel 124 being supplied from the fuel vessel 713 can be suppressed from being reduced with the operation of the fuel cell 723. Accordingly, while the occurrence of crossover can be suppressed, electrochemical reaction can be performed stably for an extended period of time in the unit cell structure 101.

In the embodiment using the structure of the permeation control film 717 as shown in FIG. 3A or 3B, the contact area between the permeation control film 735 and the fuel permeable film 745 may be variable. In such a structure, the permeability to the high-concentration fuel 725 decreases as the contact area between the fuel permeable film 745 and the permeation control film 735 increases, and thus the permeability of the high-concentration fuel 725 can be more precisely controlled. For example, such a structure may use the shutter mechanism as described later in the fourth to fourteenth embodiments.

### SECOND EMBODIMENT

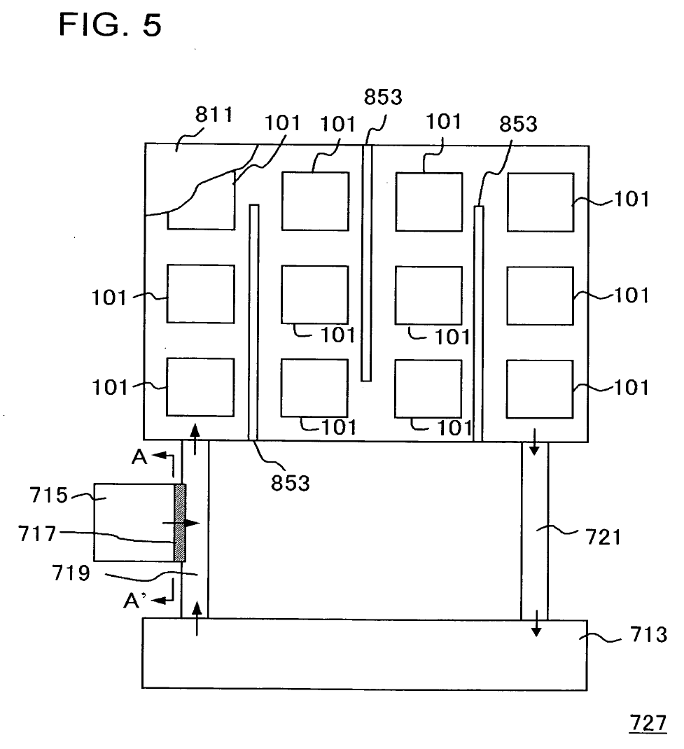

In the fuel cell 723 according to the first embodiment, the high-concentration fuel vessel 715 and the permeation control film 717 may be placed adjacent to the fuel passage 719. FIG. 5 is a diagram showing the structure of a fuel cell according to this embodiment.

In a fuel cell 727 of FIG. 5, the high-concentration fuel 725 is supplied from the high-concentration fuel vessel 715 through the fuel passage 719 such that the fuel concentration of the liquid being supplied from the fuel vessel 713 to the fuel passage 719 is set at a predetermined concentration. Thus, the concentration of the fuel component in the fuel 124 being supplied to the unit cell structure can be suppressed from being reduced and can be kept at a predetermined concentration. Therefore, while the occurrence of crossover is suppressed in the unit cell structure 101, high cell voltage can be stably obtained for an extended period of time.

In the fuel cell 727, the permeation control film 717 may have the same structure, for example, as that in the fuel cell 723 according to the first embodiment.

### THIRD EMBODIMENT

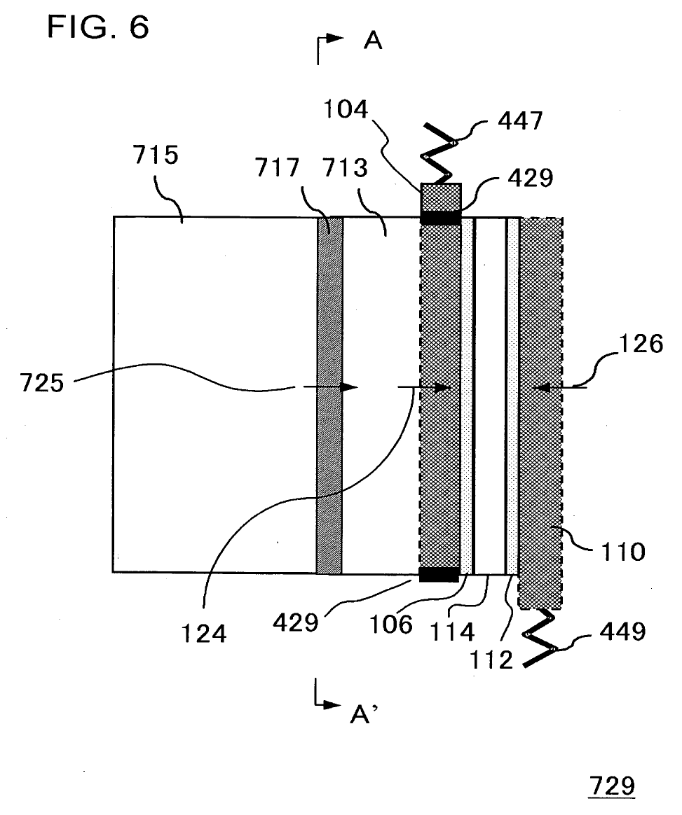

In this embodiment, the invention is applied to another structure of a fuel cell in which a liquid fuel is directly supplied to a fuel electrode. FIG. 6 is a diagram schematically showing the structure of a fuel cell 729 according to this embodiment.

In the fuel cell of FIG. 6, substrates 104 and 110 are each configured so as to serve as both a gas diffusion layer and a collector electrode. The substrates 104 and 110 have a fuel electrode-side terminal 447 and an oxidant electrode-side terminal 449, respectively. The substrates 104 and 110 may be made of a metal mesh, a porous metal sheet, a foamable metal material, or the like. In such a structure, power collection can be efficiently performed without using a metal bulk collector.

The fuel vessel 713 is joined to the substrate 104. As in the first embodiment, the high-concentration fuel vessel 715 is joined to the fuel vessel 713 through the permeation control film 717. The contact surface of the fuel vessel 713 with the substrate 104 has holes (not shown). Therefore the fuel 124 is efficiently supplied to the substrate 104 through the holes. The substrate 104 and the fuel vessel 713 may be bonded to each other with an adhesive or the like having a resistance to the fuel 124 or fixed to each other using bolts and nuts or the like.

In the fuel cell of FIG. 6, the peripheral side surface of the substrate 104 is covered with a seal 429 such that the fuel 124 is prevented from leaking out. Without a large-sized collector electrode, the fuel vessel 713 is directly in contact with the substrate 104 of the fuel electrode 102 to supply the fuel 124. Such a structure can form further slim, compact and lightweight fuel cells.

The oxidant electrode 108 may also be directly brought into contact with an oxidizer 126 such as air or oxygen to be supplied. The oxidizer 126 may be supplied to the substrate 110 of the oxidant electrode 108 through any appropriate component that does not prevent downsizing, such as a packaging component.

According to this embodiment, the concentration of the fuel component in the fuel 124 can be controlled even in the fuel cell that is configured so as to directly supply the fuel 124 to the fuel electrode 102. Thus, while the occurrence of crossover is suppressed, electrochemical reaction can be stably performed for an extended period of time, and the whole of the cell can be downsized.

While FIG. 6 illustrates a single piece of the unit cell structure 101, a plurality of unit cell structures 101 may be connected in series in a plane as in the fuel cell 723 of FIG. 1 or may be formed into a stack.

In the fuel cell 729, the permeation control film 717 may have the same structure as that in the fuel cell 723, for example, according to the first embodiment.

### FOURTH EMBODIMENT

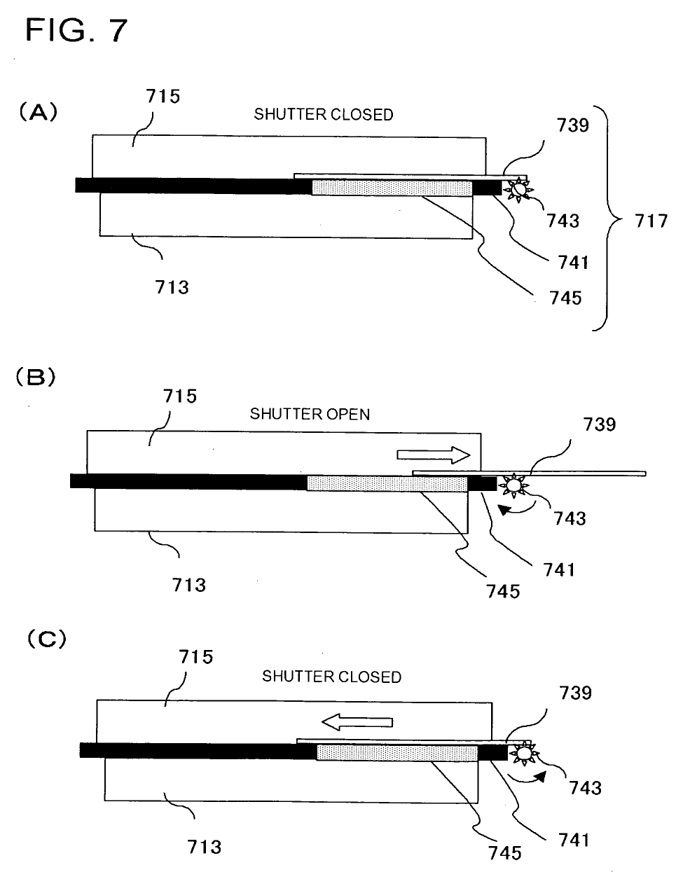

In the fuel cell according to the first to third embodiments, the permeation control film 717 may have a structure as described below. FIGS. 7A to 7C are cross-sectional views showing a structure of the permeation control film 717 placed at the boundary between the fuel vessel 713 and the high-concentration fuel vessel 715. The structure of the permeation control film 717 according to this embodiment may also be used in the structure according to the second embodiment having the permeation control film 717 placed between the fuel passage 719 and the high-concentration fuel vessel 715.

Referring to FIG. 7A, the permeation control film 717 includes a partition wall 741, a fuel permeable film 745 and a shutter 739. The fuel cell of this embodiment also includes a rotary unit 743 that controls the opening and closing state of the shutter 739.

The fuel permeable film 745 is permeable to the fuel component in the fuel 124 and supported by the partition wall 741 and placed so as to form a part of the interface between the high-concentration fuel vessel 715 and the fuel vessel 713. The fuel permeable film 745 may be any film having permeability to the fuel component and preferably has good corrosion resistance to the fuel component. For example, polymer films having resistance to the fuel component may be used. Films and others capable of serving as the solid electrolyte membrane 114 may also be used. Alternatively, metal meshes, porous metal sheets or the like may be used.

The shutter 739 is allowed to slide on the surface of the fuel permeable film 745 so as to be placed over a part or the whole of the surface of the fuel permeable film 745. For example, the shutter 739 is a flat plate having no opening. The shutter 739 is preferably made of a material resistant to corrosion or deformation with the fuel component. Examples of such a material include polymer materials such as Teflon (registered trademark), polyethylene and polypropylene; metals and ceramic materials.

The shutter 739 may include the permeation control film 735 (FIG. 2) as shown in the first embodiment so that the permeability to the high-concentration fuel 725 can be more precisely controlled.

While this embodiment and other embodiments below are described with reference to a structure where the shutter 739 is provided only on the high-concentration fuel vessel 715 side as an example, the shutter 739 may be provided on the fuel vessel 713 side or on both the fuel vessel 713 side and the high-concentration fuel vessel 715 side.

FIG. 7A shows a state where the shutter 739 is closed. In this state, the transmission of the high-concentration fuel 725 from the high-concentration fuel vessel 715 to the fuel vessel 713 is restricted.

FIG. 7B shows a state where the shutter 739 is open. The opening and closing of the shutter 739 is performed by rotating the rotary unit 743 which is engaged with the shutter 739 and allowed the shutter 739 to slide. In the process from FIG. 7A to FIG. 7B, the shutter 739 is opened by clockwise rotation of the rotary unit 743.

FIG. 7C shows a state where the shutter 739 is closed again. In the process from FIG. 7B to FIG. 7C, the shutter 739 is closed by counterclockwise rotation of the rotary unit 743.

In the permeation control film 717 with such a structure, the fuel permeable film 745 may be the permeation control film 735 (FIG. 2) as shown in the first embodiment. When the permeation control film 735 is used, the ability of the film itself to control the transmission of the fuel component is combined with the control of the fuel component transmission by the opening and closing of the shutter 739 so that the concentration of the fuel component in the fuel vessel 713 can be more precisely controlled. For example, since the optimal concentration of methanol in the fuel 124 varies with temperature, the opening area formed by the shutter 739 may be adjusted so as to provide high concentrations at low temperatures where higher methanol concentrations are necessary and so as to provide low concentrations at high temperatures where electricity can be generated at relatively low concentrations.

Engaged gears or the like may be used for a movement for the opening and closing of the shutter 739 with the rotary unit 743. The opening and closing of the shutter 739 may also be performed using electric power of a motor or the like as a driving force or using an electric signal converted from a force accumulated by human power through a spiral spring or the like. In these mechanisms, the current value, the knob position and the like may be variable such that the opening area formed by the shutter 739 can be changed by control of the current value or the like. Thus, the exposed area of the fuel permeable film 745 can be controlled to the desired size. Alternatively, a mechanism may be provided in which the concentration of the fuel component in the fuel vessel 713 or in each of the fuel vessel 713 and the high-concentration fuel vessel 715 is monitored such that the shutter 739 is opened when the concentration decreases to lower than a specified value and that the shutter 739 is closed when the concentration increases.

While the fuel permeable film 745 is provided as a boundary part between the fuel vessel 713 and the high-concentration fuel vessel 715 in this embodiment, the fuel permeable film 745 may form the whole of a partition wall in place of the partition wall 741.

### FIFTH EMBODIMENT

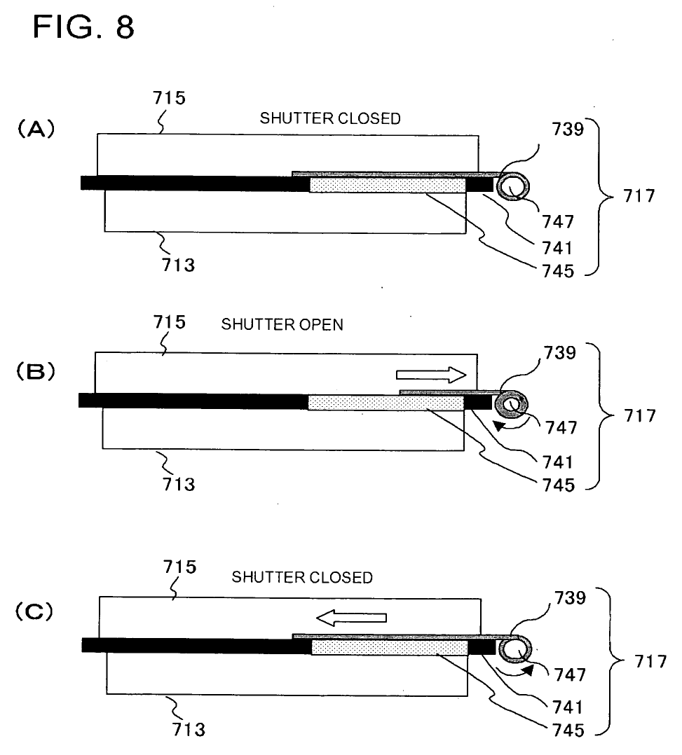

The fuel cell according to the first to third embodiments may have a structure as described below. FIGS. 8A to 8C are cross-sectional views showing the structure of the permeation control film 717 placed at the boundary between the fuel vessel 713 and the high-concentration fuel vessel 715. The structure of the permeation control film 717 according to this embodiment may also be used in the structure according to the second embodiment having the permeation control film 717 placed between the fuel passage 719 and the high-concentration fuel vessel 715.

Referring to FIG. 8, the permeation control film 717 includes a partition wall 741, a fuel permeable film 745 and a shutter 739. The fuel cell of this embodiment also includes a take-up unit 747 that winds up the shutter 739. Referring to FIG. 8, the shutter 739 is allowed to slide on the surface of the fuel permeable film 745 when wound up by the take-up unit 747 in the structure according to the fourth embodiment (FIGS. 7A to 7C).

FIG. 8A shows a state where the shutter 739 is closed. In this state, the transmission of the high-concentration fuel 725 from the high-concentration fuel vessel 715 to the fuel vessel 713 is restricted.

FIG. 8B shows a state where the shutter 739 is open. The opening and closing of the shutter 739 is performed by rotating the take-up unit 747 that winds up the shutter 739. In the process from FIG. 8A to FIG. 8B, the shutter 739 is opened by clockwise rotation of the take-up unit 747.

FIG. 8C shows a state where the shutter 739 is closed again. In the process from FIG. 8B to FIG. 8C, the shutter 739 is closed by counterclockwise rotation of the take-up unit 747.

The driving force for the take-up of the shutter 739 with the take-up unit 747 may be derived from a motor, a spiral spring, or the like. The concentration of the fuel component in the fuel vessel 713 or in each of the fuel vessel 713 and the high-concentration fuel vessel 715 may also be monitored such that the shutter 739 is opened when the concentration decreases to lower than a specified value and that the shutter 739 is closed when the concentration increases. For example, the opening area formed by the shutter 739 may be changed by current value control or the like.

While the fuel permeable film 745 is also provided as a boundary part between the fuel vessel 713 and the high-concentration fuel vessel 715 in this embodiment, the fuel permeable film 745 may form the whole of a partition wall in place of the partition wall 741.

If the shutter 739 includes the permeation control film 735 (FIG. 2) as shown in the first embodiment, the permeability to the high-concentration fuel 725 can be more precisely controlled.

### SIXTH EMBODIMENT

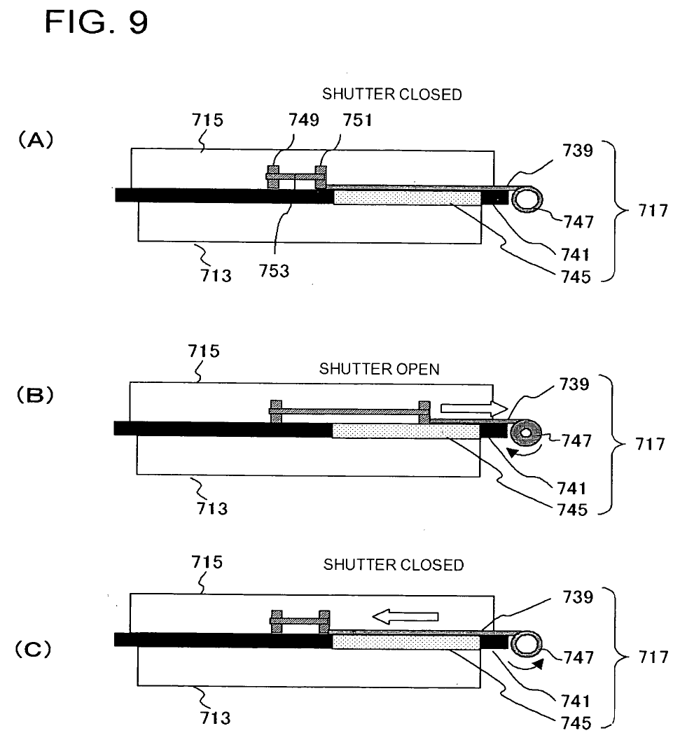

In this embodiment, the permeation control film 717 according to the fifth embodiment is provided with a supplemental unit that assists, by elastic force, the opening and closing of the shutter 739 with the take-up unit 747. FIGS. 9A to 9C are cross-sectional views showing the structure of the permeation control film 717 according to this embodiment.

The fuel cell of this embodiment is according to the fifth embodiment and further includes columns 749 and 751 and an elastic member 753. The column 749 is fixed on a predetermined position of the partition wall 741, while the column 751 is slidably provided on the partition wall 741 and coupled to the end of the shutter 739.

The columns 749 and 751 are connected through the elastic member 753. When the shutter 739 is opened, the elastic member 753 extends so that the column 751 is allowed to move away from the column 749. When the shutter 739 is closed, the elastic member 753 contracts so that the column 751 is allowed to move toward the column 749.

FIG. 9A shows a state where the shutter 739 is closed. In this state, the transmission of the high-concentration fuel 725 from the high-concentration fuel vessel 715 to the fuel vessel 713 is restricted.

FIG. 9B shows a state where the shutter 739 is open. The opening and closing of the shutter 739 is performed by rotating the take-up unit 747 that winds up the shutter 739. In the process from FIG. 9A to FIG. 9B, the shutter 739 is opened by clockwise rotation of the take-up unit 747. In this process, the column 751 is allowed to move together with the shutter 739 so that the elastic member 753 extends.

FIG. 9C shows a state where the shutter 739 is closed again. In the process from FIG. 9B to FIG. 9C, the shutter 739 is closed by counterclockwise rotation of the take-up unit 747. In this process, a force is applied to the column 751 and the shutter 739 so as to allow the extending elastic member 753 to contract so that the closing of the shutter 739 is accelerated.

As described above, if the elastic member 753 is provided, a force can be applied so as to close the shutter 739, and thus such a structure can assist the closing of the shutter 739. For example, the elastic member 753 may be a spring or rubber or the like. The material for the elastic member 753 may have corrosion resistance to the fuel component of the fuel 124.

In this embodiment, the shutter 739 may also include the permeation control film 735 (FIG. 2) as shown in the first embodiment so that the permeability to the high-concentration fuel 725 can be more precisely controlled.

### SEVENTH EMBODIMENT

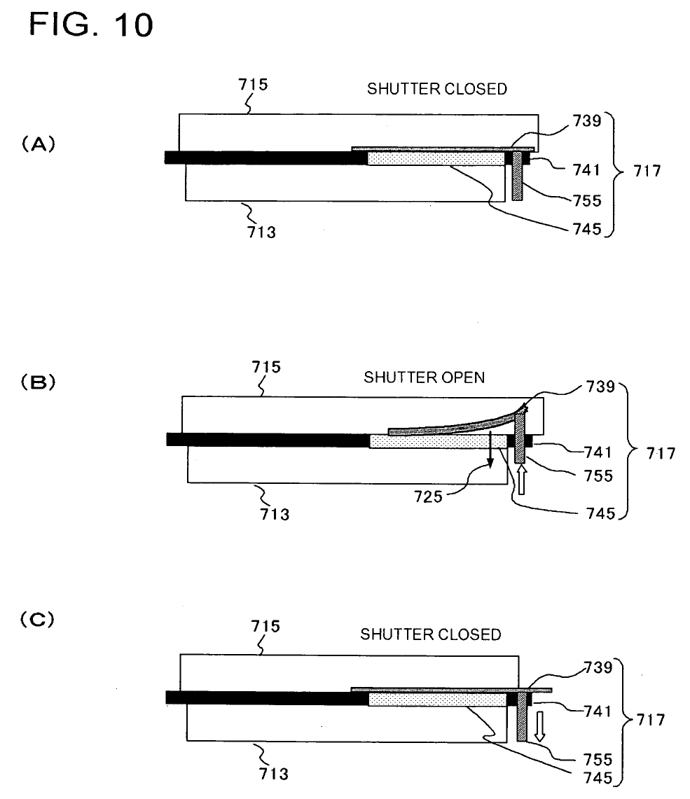

The fuel cell according to the first to third embodiments may have a structure as described below. FIGS. 10A to 10C are cross-sectional views showing the structure of the permeation control film 717 provided at the boundary between the fuel vessel 713 and the high-concentration fuel vessel 715. The structure of the permeation control film 717 according to this embodiment may also be used in the structure according to the second embodiment having the permeation control film 717 placed between the fuel passage 719 and the high-concentration fuel vessel 715.

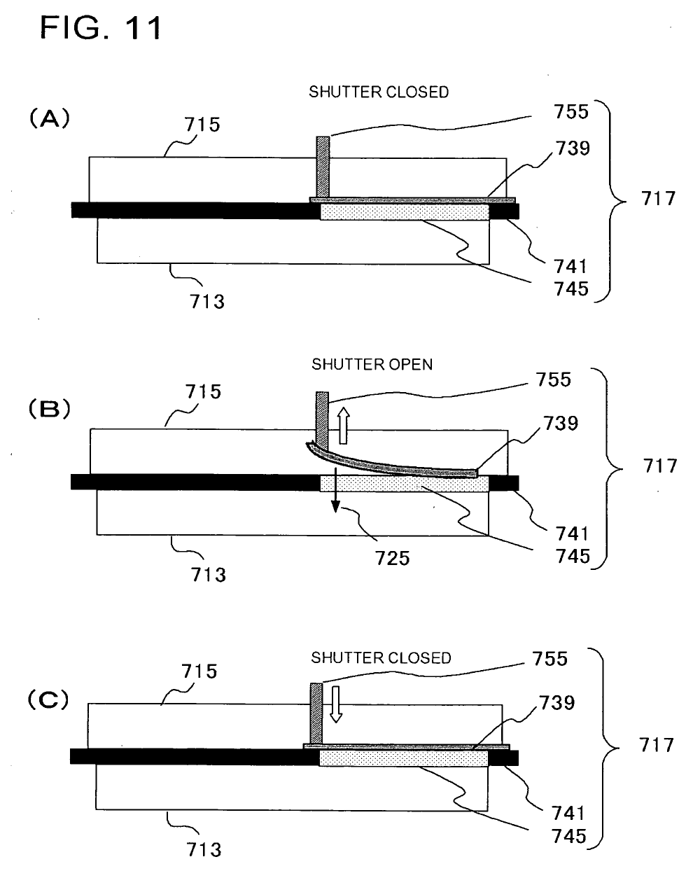

Referring to FIGS. 10A to 10C, the permeation control film 717 includes a partition wall 741, a fuel permeable film 745 and a shutter 739. The fuel cell of this embodiment also includes a shaft 755 coupled to the shutter 739. FIGS. 10A to 11C shows a pop-up structure that is according to the fourth embodiment (FIGS. 7A to 7C) and also includes a shaft 755 with which the shutter 739 is pushed upward.

FIG. 10A shows a state where the shutter 739 is closed. In this state, the shutter 739 is in close contact with the fuel permeable film 745 so that the transmission of the high-concentration fuel 725 from the high-concentration fuel vessel 715 to the fuel vessel 713 is restricted.

FIG. 10B shows a state where the shutter 739 is open. The opening and closing of the shutter 739 is performed by allowing the shaft 755 pushing the shutter 739 to move upward and downward as shown in the drawing. In the process from FIG. 10A to FIG. 10B, the shaft 755 is allowed to move upward so that the shutter 739 is pushed up, so that a space is formed between the shutter 739 and the fuel permeable film 745. Through the space, the high-concentration fuel 725 is allowed to move from the high-concentration fuel vessel 715 to the fuel vessel 713.

FIG. 10C shows a state where the shutter 739 is closed again. In the process from FIG. 10B to FIG. 10C, the shaft 755 is allowed to move downward as shown in the drawing so that the shutter 739 is brought into contact with the fuel permeable film 745.

In the structure according to this embodiment, the shutter 739 is pushed up with the shaft 755 such that the fuel permeable film 745 is brought into contact with the high-concentration fuel 725 in the high-concentration fuel vessel 715, and thus the fuel component concentration in the fuel vessel 713 can be controlled. The pushing-up movement of the shaft 755 may be performed by pushing up the rod-shaped shaft 755 through rotation of an egg-shaped cam or by screwing the screw shaft 755. The opening area formed by the shutter 739 may be changed by current value control or the like.

While the fuel permeable film 745 is also provided at a part of boundary part between the fuel vessel 713 and the high-concentration fuel vessel 715 in this embodiment, the fuel permeable film 745 may form the whole of a partition wall in place of the partition wall 741.

The shutter 739 may also include the permeation control film 735 (FIG. 2) as shown in the first embodiment so that the permeability to the high-concentration fuel 725 can be more precisely controlled.

### EIGHTH EMBODIMENT

In the fuel cell according to the seventh embodiment, a pull-up structure is provided according to this embodiment to open and close the shutter 739 by means of the shaft 755. FIG. 11 is a cross-sectional view showing the structure of the permeation control film 717 according to this embodiment.

FIG. 11A shows a state where the shutter 739 is closed. The shaft 755 is provided at the end of the shutter 739 at the center portion of the high-concentration fuel vessel 715. In this state, the shutter 739 is in close contact with the fuel permeable film 745 so that the transmission of the high-concentration fuel 725 from the high-concentration fuel vessel 715 to the fuel vessel 713 is restricted.

FIG. 11B shows a state where the shutter 739 is open. The opening and closing is performed by allowing the shaft 755 pulling the shutter 739 to move upward and downward as shown in the drawing. In the process from FIG. 11A to FIG. 11B, the shaft 755 is allowed to move upward so that the shutter 739 is pulled up. Thereby a space is formed between the shutter 739 and the fuel permeable film 745. Through the space, the high-concentration fuel 725 is allowed to move from the high-concentration fuel vessel 715 to the fuel vessel 713.

FIG. 11C shows a state where the shutter 739 is closed again. In the process from FIG. 11B to FIG. 11C, the shaft 755 is allowed to move downward as shown in the drawing so that the shutter 739 is brought into contact with the fuel permeable film 745.

In the structure according to this embodiment, the shutter 739 is pulled up with the shaft 755 such that the fuel permeable film 745 is brought into contact with the fuel component in the high-concentration fuel vessel 715, and thus the fuel component concentration in the fuel vessel 713 can be controlled. The pulling-up movement of the shaft 755 may be performed using the way described in the seventh embodiment.

In this embodiment, the shutter 739 may also include the permeation control film 735 (FIG. 2) as shown in the first embodiment so that the permeability to the high-concentration fuel 725 can be more precisely controlled.

### NINTH EMBODIMENT

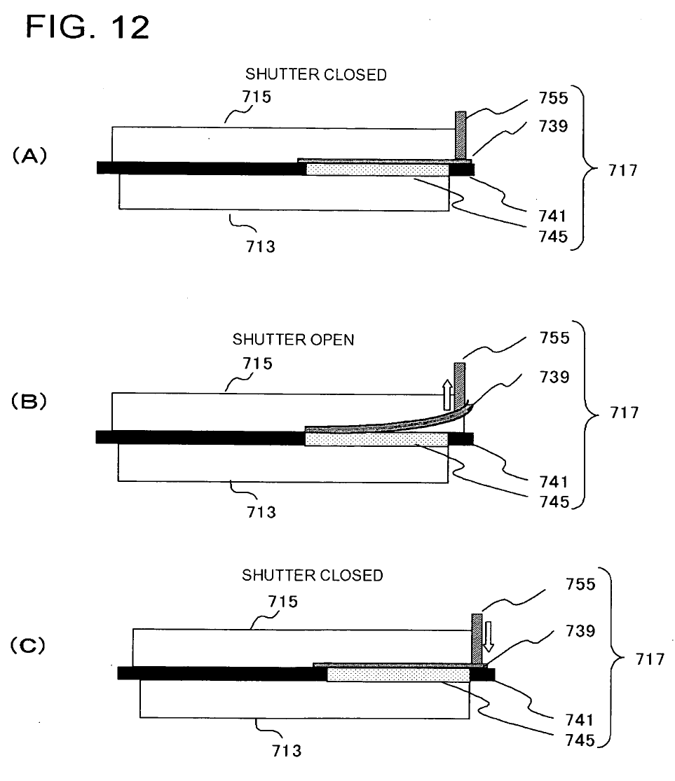

In the fuel cell according to the eighth embodiment, the shaft 755 according to this embodiment is provided at the end of the shutter 739 on the end side of the high-concentration fuel vessel 715. FIGS. 12A to 12C are cross-sectional views showing the structure of the permeation control film 717 according to this embodiment and correspond to the structures of FIGS. 11A to 11C, respectively.

Even with the shaft 755 placed on the end side of the high-concentration fuel vessel 715 in the pull-up mechanism that opens and closes the shutter 739 by means of the shaft 755, the transmission of the high-concentration fuel 725 can be controlled as in the case of the permeation control film 717 according to the eighth embodiment.

In this embodiment, the shutter 739 may also include the permeation control film 735 (FIG. 2) as shown in the first embodiment so that the permeability to the high-concentration fuel 725 can be more precisely controlled.

### TENTH EMBODIMENT

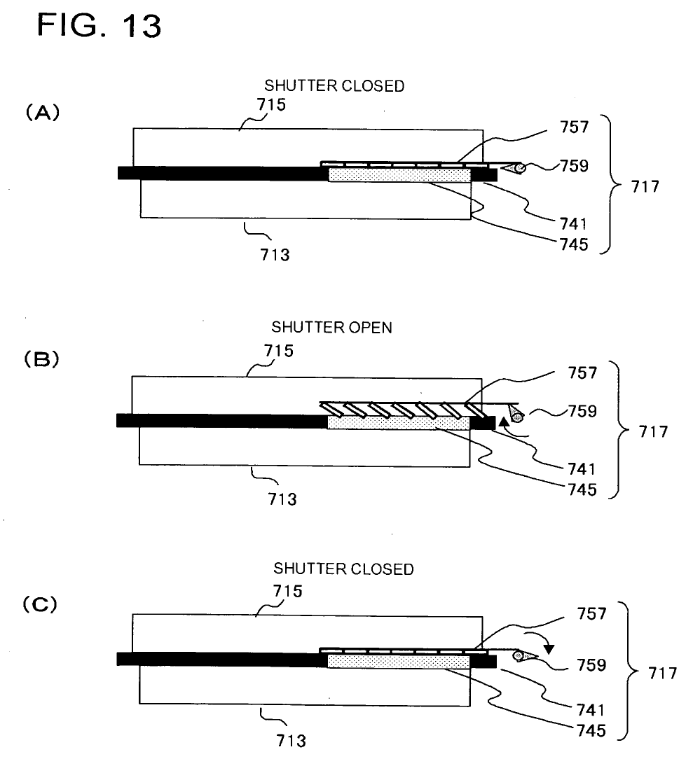

The fuel cell according to the first to third embodiments may also have a structure as described below. FIGS. 13A to 13C are cross-sectional views showing the structure of the permeation control film 717 provided at the boundary between the fuel vessel 713 and the high-concentration fuel vessel 715. The structure of the permeation control film 717 according to this embodiment may also be used in the structure according to the second embodiment having the permeation control film 717 placed between the fuel passage 719 and the high-concentration fuel vessel 715.

Referring to FIG. 13, the permeation control film 717 includes a partition wall 741, a fuel permeable film 745 and a shutter 757. The fuel cell of this embodiment also includes a knob 759 coupled to the shutter 757. The shutter 757 is in the form of a blind and opened and closed by turning the knob 759.

FIG. 13A shows a state where the shutter 757 is closed. In this state, each plate constituting the shutter 757 is in close contact with the fuel permeable film 745, and thus the transmission of the high-concentration fuel 725 from the high-concentration fuel vessel 715 to the fuel vessel 713 is restricted.

FIG. 13B shows a state where the shutter 757 is open. In the process from FIG. 13A to FIG. 13B, each plate of the shutter 757 is lifted by turning the knob 759 clockwise as shown in the drawing, so that a space is formed between the shutter 757 and the fuel permeable film 745. Through the space, the fuel component is allowed to move from the high-concentration fuel vessel 715 to the fuel vessel 713.

FIG. 13C shows a state where the shutter 739 is closed again. In the process from FIG. 13B to FIG. 13C, the knob 759 is turned counterclockwise as shown in the drawing such that the shutter 757 is brought into contact with the fuel permeable film 745 again.

In the structure according to this embodiment, the shutter 757 is lifted by means of the knob 759 such that the fuel permeable film 745 is brought into contact with the high-concentration fuel 725 in the high-concentration fuel vessel 715, and thus the fuel component concentration in the fuel vessel 713 can be controlled. For example, a shaft may be used in place of the knob 759. In this case, the lifting movement of the shutter 757 may be performed by pushing up the shaft through rotation of an egg-shaped cam. The opening area formed by the shutter 757 may be changed by current value control or the like.

While the fuel permeable film 745 is also provided at a part of boundary between the fuel vessel 713 and the high-concentration fuel vessel 715 in this embodiment, the fuel permeable film 745 may form the whole of a partition wall in place of the partition wall 741.

The shutter 739 may also include the permeation control film 735 (FIG. 2) as shown in the first embodiment so that the permeability to the high-concentration fuel 725 can be more precisely controlled.

### ELEVENTH EMBODIMENT

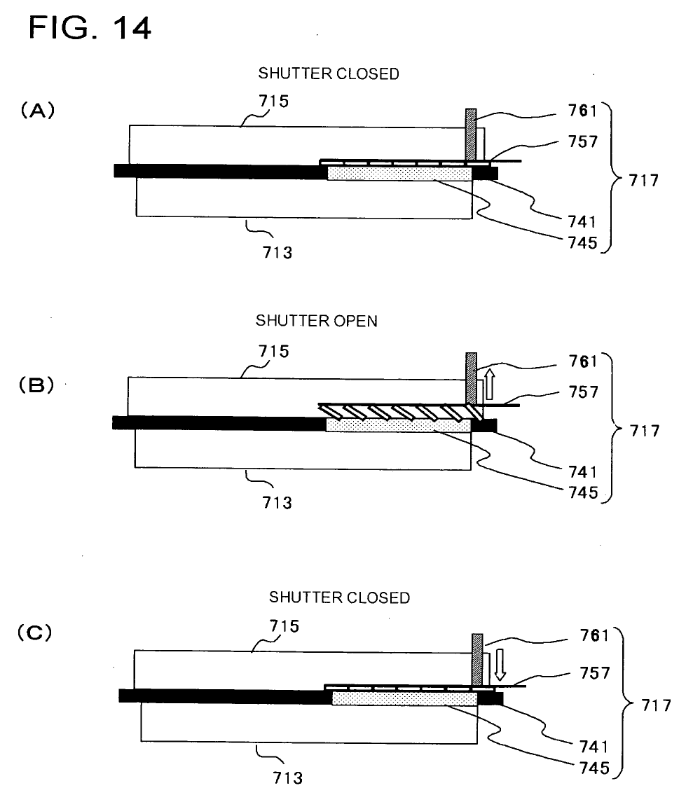

In the fuel cell according to the tenth embodiment, a shaft 761 is provided in place of the knob 759 at the end of the shutter 757 on the end side of the high-concentration fuel vessel 715 according to this embodiment. FIGS. 14A to 14C are cross-sectional views showing the structure of the permeation control film 717 according to this embodiment and correspond to the structures of FIGS. 13A to 13C, respectively. In this embodiment, the shutter 757 is divided into small parts like a blind, and a shaft 761 connecting the parts of the shutter 757 is lifted as shown in the drawing such that the opening area formed by the shutter 757 is controlled.

Even with the shaft 761 placed on the end side of the high-concentration fuel vessel 715 in the pull-up mechanism that opens and closes the shutter 757 by means of the shaft 761, the transmission of the high-concentration fuel 725 can be controlled as in the case of the permeation control film 717 according to the tenth embodiment.

In this embodiment, the shutter 739 may also include the permeation control film 735 (FIG. 2) as shown in the first embodiment so that the permeability to the high-concentration fuel 725 can be more precisely controlled.

### TWELFTH EMBODIMENT

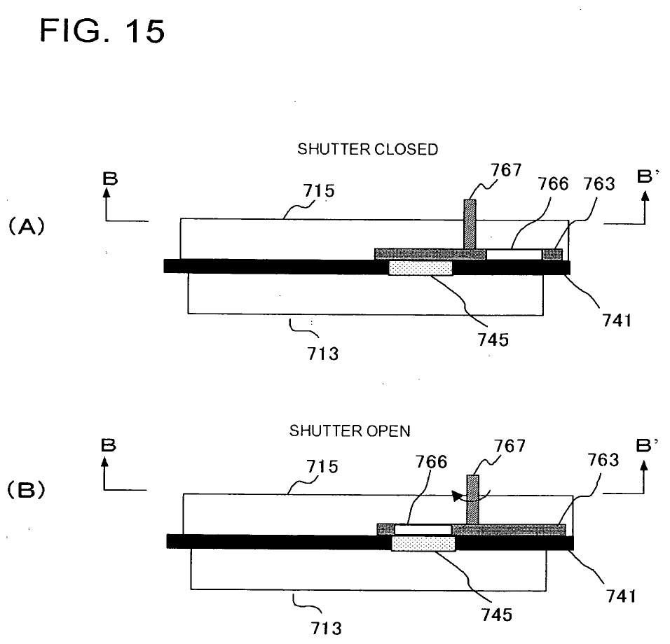

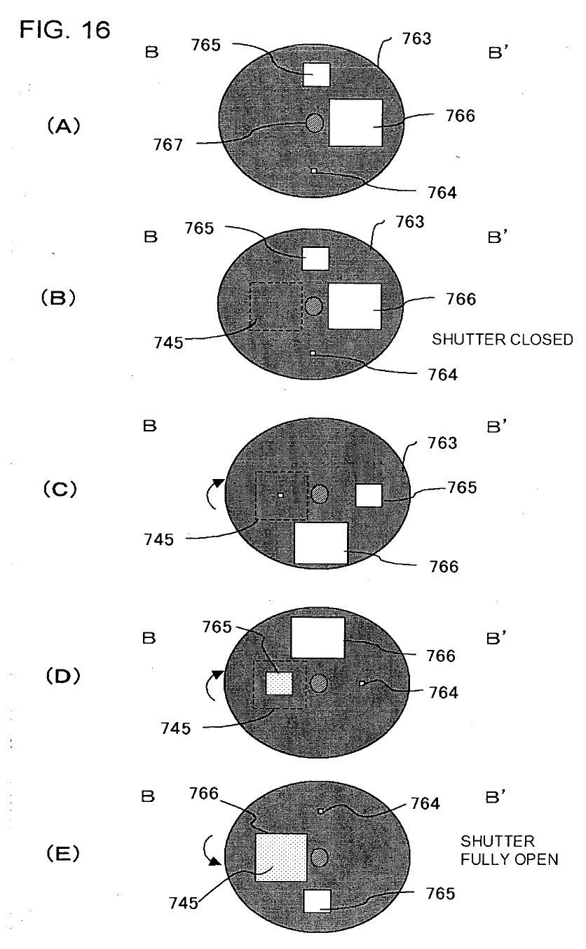

The fuel cell according to the first to third embodiments may have a structure as described below. FIGS. 15A and 15B are cross-sectional views showing the structure of the permeation control film 717 provided at the boundary between the fuel vessel 713 and the high-concentration fuel vessel 715. FIG. 16A is a plan view schematically showing the shape of a shutter 763 in a cross section along line B-B′ of FIGS. 15A and 15B.

The structure of the permeation control film 717 according to this embodiment may also be used in the structure according to the second embodiment having the permeation control film 717 placed between the fuel passage 719 and the high-concentration fuel vessel 715.

Referring to FIG. 15, the permeation control film 717 includes a partition wall 741, a fuel permeable film 745 and a shutter 763. The fuel cell of this embodiment also includes a knob 767 joined to the shutter 763. The shutter 763 is disk-shaped and has three openings 764 to 766 of different sizes. The order of the opening areas, from smallest to largest, is the openings 764, 765 and 766. It will be understood that the number of the openings is not limited to three and may be any number of one or more.

FIG. 15A shows a state where the shutter 763 is closed. In this state, the position of the opening 765 provided in the shutter 763 does not coincide with that of the fuel permeable film 745, and thus the transmission of the high-concentration fuel 725 from the high-concentration fuel vessel 715 to the fuel vessel 713 is restricted.

FIG. 15B shows a state where the shutter 763 is open. In the process from FIG. 15A to FIG. 15B, the knob 767 is turned clockwise as shown in the drawing such that the opening 765 provided in the shutter 763 is positioned right above the fuel permeable film 745. Accordingly, the high-concentration fuel 725 is allowed to move from the high-concentration fuel vessel 715 to the fuel vessel through the opening 765.

FIGS. 16A to 16E show states where the size of the exposed part of the fuel permeable film 745 is changed by turning the knob 767.

FIG. 16B corresponding to FIG. 15A is a top view showing the relationship between the positions of the shutter 763 and the fuel permeable film 745, in which none of the openings 764 to 766 is positioned right above the fuel permeable film 745 such that the shutter 763 is in a closed state.

FIG. 16C shows a state where the opening 764 with the smallest opening area is positioned right above the fuel permeable film 745. In this state, the shutter 763 is slightly open such that a very small amount of the high-concentration fuel 725 is allowed to move from the high-concentration fuel vessel 715 to the fuel vessel 713.

FIG. 16D shows a state where the opening 765 with the second smallest opening area is positioned right above the fuel permeable film 745. In this state, the shutter 763 is about ¼ open such that a small amount of the high-concentration fuel 725 is allowed to move from the high-concentration fuel vessel 715 to the fuel vessel 713.

FIG. 16E shows a state where the opening 765 with the largest opening area is positioned right above the fuel permeable film 745. In this state, the shutter 763 is fully open such that a large amount of the high-concentration fuel 725 is allowed to move from the high-concentration fuel vessel 715 to the fuel vessel 713.

The fuel cell according to the first to third embodiments may be used in such a manner as described below. At the initial stage, none of the positions of the openings 764, 765 and 766 does not coincide with that of the fuel permeable film 745, and thus operation is performed in a fully-closed state. When the concentration of the fuel component in the fuel vessel 713 is reduced by the operation of the cell, the knob 767 is turned under control such that the opening area is gradually increased, and the openings 764, 765 and 766 are used in this order in order to increase the opening area. When the concentration of the fuel component in the fuel vessel 713 becomes high enough, the opening area is reduced.

In this embodiment, the face of the shutter 763 is rotated on the fuel permeable film 745 by turning the knob 767 so that the positions of the openings 764 to 766 formed by the shutter 763 are shifted. In this mechanism, the shielded area of the fuel permeable film 745 can be adjusted, and thus, the amount of transfer of the high-concentration fuel 725 through the fuel permeable film 745 can be more precisely controlled. In this structure having the fuel permeable film 745 in contact with the high-concentration fuel 725 in the high-concentration fuel vessel 715, the concentration of the fuel component in the fuel vessel 713 can be controlled.

While the fuel permeable film 745 is also provided as a part of boundary between the fuel vessel 713 and the high-concentration fuel vessel 715 in this embodiment, the fuel permeable film 745 may form the whole of a partition wall in place of the partition wall 741.

The shutter 739 may also include the permeation control film 735 (FIG. 2) as shown in the first embodiment so that the permeability to the high-concentration fuel 725 can be more precisely controlled.

### THIRTEENTH EMBODIMENT

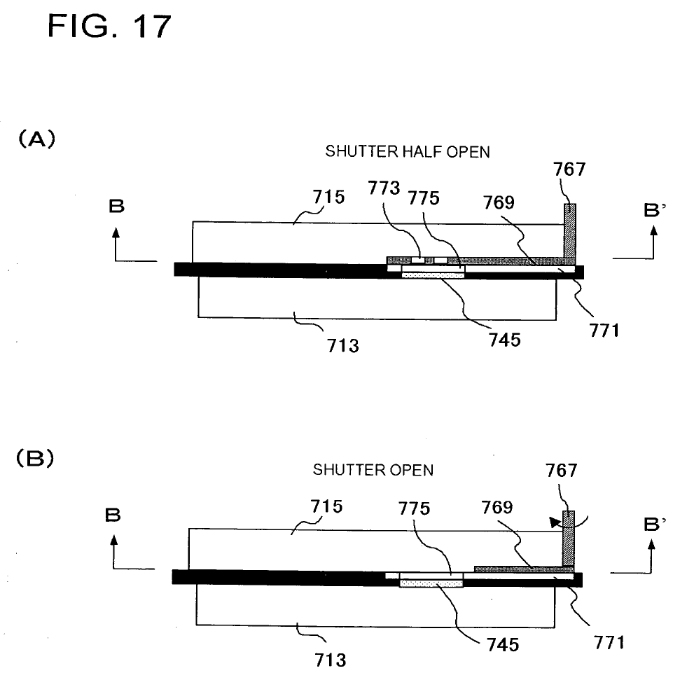

The fuel cell according to the first to third embodiments may have a structure as described below. FIGS. 17A and 17B are cross-sectional views showing the structure of the permeation control film 717 provided at the boundary between the fuel vessel 713 and the high-concentration fuel vessel 715.

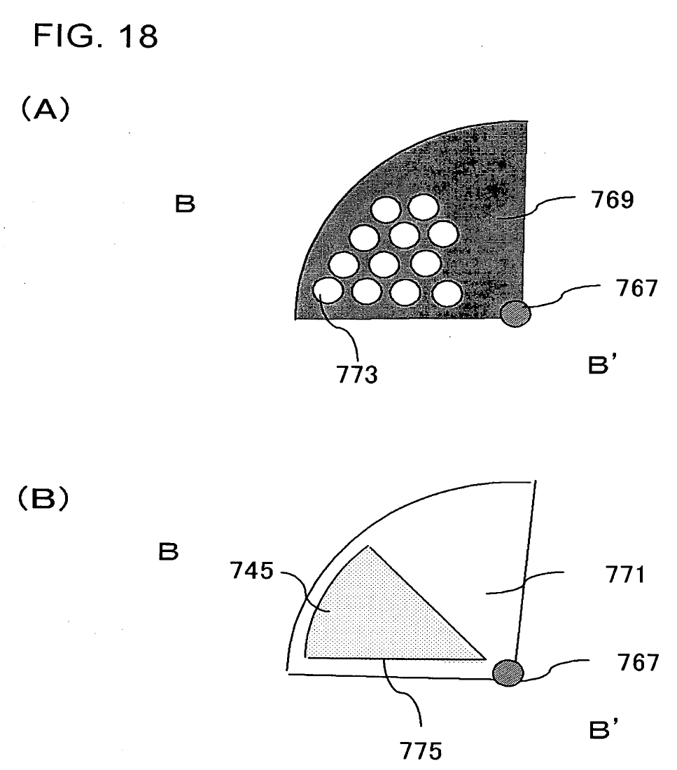

FIG. 18A is a plan view schematically showing the shape of a shutter 769 in a cross section along line B-B′ of FIGS. 17A and 17B. FIG. 18B is a plan view schematically showing the shape of an opening-formed partition wall 771 in a cross section along line B-B′ of FIGS. 17A and 17B.

The structure of the permeation control film 717 according to this embodiment may also be used in the structure according to the second embodiment having the permeation control film 717 placed between the fuel passage 719 and the high-concentration fuel vessel 715.

Referring to FIGS. 17A and 17B, the permeation film 717 includes a partition wall 741, a fuel permeable film 745, a shutter 769, and an opening-formed partition wall 771. The fuel cell of this embodiment also includes a knob 767 joined to the shutter 769.

The shutter 769 is provided on the fuel permeable film 745 and has a plurality of openings 773. The number of the openings 773 has no limitation. The shutter 769 is configured such that its face is rotated around the knob 767 providing an axis by turning the knob 767.

The opening-formed partition wall 771 is fixed into the partition wall 741 and has an opening 775. The opening 775 is placed right above the fuel permeable film 745 and as large as the fuel permeable film 745. In this embodiment, while the shutter 769 and the fuel permeable film 745 are each fan-shaped in the illustration, these are not limited to the fan-shaped and may be circle-shaped or the like. The shutter 769 has a plurality of openings 773. The number and shape of the openings 773 may be appropriately selected depending on the fuel permeability of the fuel permeable film 745.

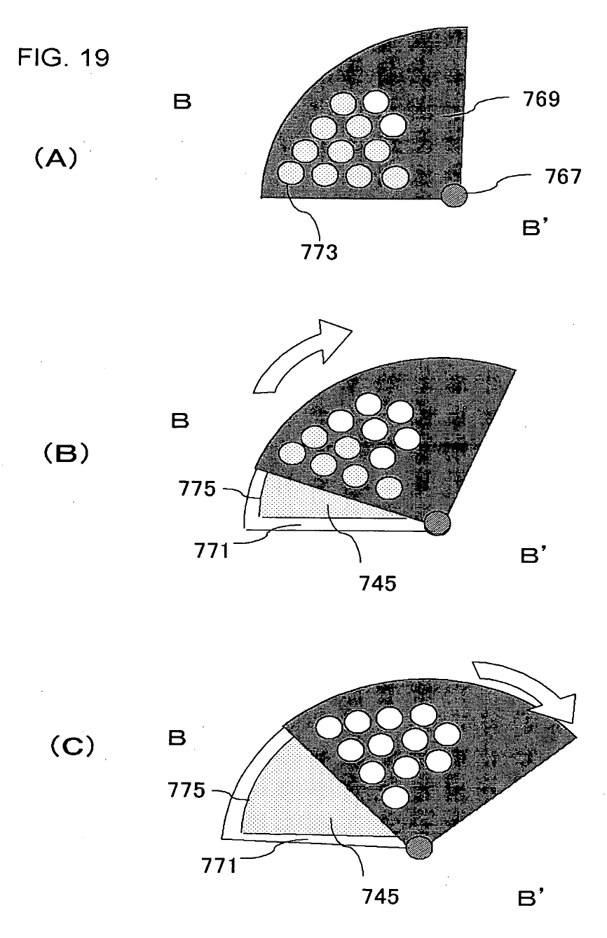

FIGS. 19A to 19C show states where the size of the exposed part of the opening 775 is changed by turning the knob 767.

FIG. 19A corresponding to FIG. 17A is a top view showing a state where the shutter 769 and the opening-formed partition wall 771 overlap one another. In this state, the opening 775 provided in the opening-formed partition wall 771 is covered with the shutter 769 and thus shielded. Since the opening 775 is half open, the fuel permeable film 745 is exposed only at a part where the openings 773 and the opening 775 overlap one another. Through the exposed part, the high-concentration fuel 725 is allowed to move from the high-concentration fuel vessel 715 to the fuel vessel 713.

FIG. 19B is a top view showing a state where the shutter 769 and the opening-formed partition wall 771 partially overlap one another. In this state, the opening 775 provided in the opening-formed partition wall 771 is partially covered with the shutter 769 and thus shielded. Thus, the fuel permeable film 745 is exposed at a part where the openings 773 and the opening 775 overlap one another and at a part of the opening-formed partition wall 771 not covered with the shutter 769 and thus exposed. Through these exposed parts, the high-concentration fuel 725 is allowed to move from the high-concentration fuel vessel 715 to the fuel vessel 713.

FIG. 19C corresponding to FIG. 17B is a top view showing a state where the shutter 769 and the opening-formed partition wall 771 do not overlap one another. In this state, the opening 775 provided in the opening-formed partition wall 771 is not covered with the shutter 769 and thus exposed, so that the fuel permeable film 745 is exposed through the opening 775. Through the exposed part, the high-concentration fuel 725 is allowed to move from the high-concentration fuel vessel 715 to the fuel vessel 713.

For example, the fuel cell having the permeation control film 717 of this embodiment may be used in such a manner as described below. At the initial stage, the cell is operated in a state where the shutter 769 and the opening-formed partition wall 771 overlap one another. When the concentration of the fuel component in the fuel vessel 713 is reduced by the operation of the cell, the knob 767 is turned under control such that the opening area of the opening 775 is gradually increased, and the overlap between the shutter 769 and the opening-formed partition wall 771 is reduced. When the concentration of the fuel component in the fuel vessel 713 becomes high enough, the overlap between the shutter 769 and the opening-formed partition wall 771 is increased.

In this embodiment, the position of the shutter 769 is shifted by turning the knob 767 so that the shielded area of the fuel permeable film 745 can be adjusted. Thus, the amount of transfer of the high-concentration fuel 725 through the fuel permeable film 745 can be more precisely controlled. In this structure having the fuel permeable film 745 in contact with the high-concentration fuel 725 in the high-concentration fuel vessel 715, the concentration of the fuel component in the fuel vessel 713 can be controlled.

In the structure having the opening-formed partition wall 771, the fuel permeable film 745 is not in direct contact with the shutter 769. Thus, even when the fuel permeable film 745 is deformed or the like, the movement of the shutter 769 can be prevented from being blocked, so that the amount of transmission of the high-concentration fuel 725 can be more stably adjusted.

While the fuel permeable film 745 is also provided as a part of boundary between the fuel vessel 713 and the high-concentration fuel vessel 715 in this embodiment, the fuel permeable film 745 may form the whole of the boundary in place of the partition wall 741.

In this embodiment, while a case where all the openings 773 are equal in size is described as an example, the openings 773 may be arranged such that their sizes vary stepwise. In such an arrangement, the exposed area of the fuel permeable film 745 may vary stepwise so that the amount of transmission of the high-concentration fuel 725 can be more precisely controlled.

The shutter 739 may also include the permeation control film 735 (FIG. 2) as shown in the first embodiment so that the permeability to the high-concentration fuel 725 can be more precisely controlled.

### FOURTEENTH EMBODIMENT

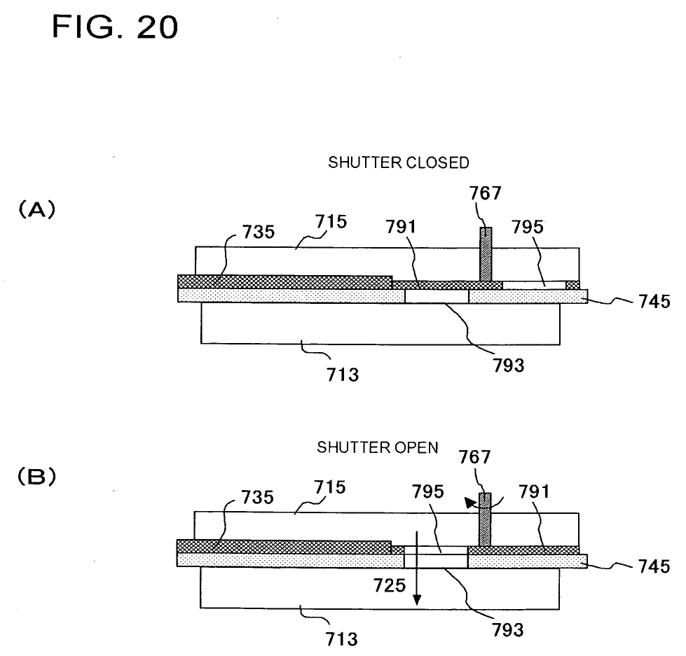

The fuel cell according to the first to third embodiments may have a structure as described below. FIGS. 20A and 20B are cross-sectional views showing the structure of the permeation control film 717 provided at the boundary between the fuel vessel 713 and the high-concentration fuel vessel 715.

The structure of the permeation control film 717 according to this embodiment may also be used in the structure according to the second embodiment having the permeation control film 717 placed between the fuel passage 719 and the high-concentration fuel vessel 715.

Referring to FIGS. 20A and 20B, the permeation control film 717 includes a fuel permeable film 745, a permeation control film 735 placed on a part of the fuel permeable film 745, and a shutter 791 placed on another part of the fuel permeable film 745. The fuel cell of this embodiment also includes a knob 767 joined to the shutter 791.

The fuel permeable film 745 has an opening 793. The shutter 791 is disk-shaped and formed of the permeation control film 735 and has an opening 795. The shape and number of the openings 793 and 795 may be arbitrarily selected.

FIG. 20A shows a state where the shutter 791 is closed. In this state, the position of the opening 795 provided in the shutter 791 does not coincide with that of the opening 793 of the fuel permeable film 745 so that the transmission of the high-concentration fuel 725 from the high-concentration fuel vessel 715 to the fuel vessel 713 is restricted and controlled depending on the permeability of the permeation control film 735 to the high-concentration fuel 725.

FIG. 20B shows a state where the shutter 791 is open. In the process from FIG. 20A to FIG. 20B, the knob 767 is turned clockwise as shown in the drawing such that the opening 795 provided in the shutter 791 is positioned right above the opening 793 of the fuel permeable film 745. In this process, the high-concentration fuel 725 is allowed to move from the high-concentration fuel vessel 715 to the fuel vessel 713 through the openings 795 and 793.

In this embodiment, the fuel permeable film 745 has an opening 793, and the shutter 791 is configured so as to be rotated on the fuel permeable film 745 by turning the knob 767. Thus, the position of the opening 795 formed to the shutter 791 can be shifted. In such a mechanism, if the concentration of the high-concentration fuel 725 in the high-concentration fuel vessel 715 becomes suitable for supply to the unit cell structure 101, a part of the boundary between the fuel vessel 713 and the high-concentration fuel vessel 715 may be fully opened. Thus, the supply of the high-concentration fuel 725 can be appropriately controlled.

In the structure as shown in FIGS. 20A and 20B, the fuel permeable film 745 may also be attached to the fuel vessel 713 side surface of the permeation control film 735.

### FIFTEENTH EMBODIMENT

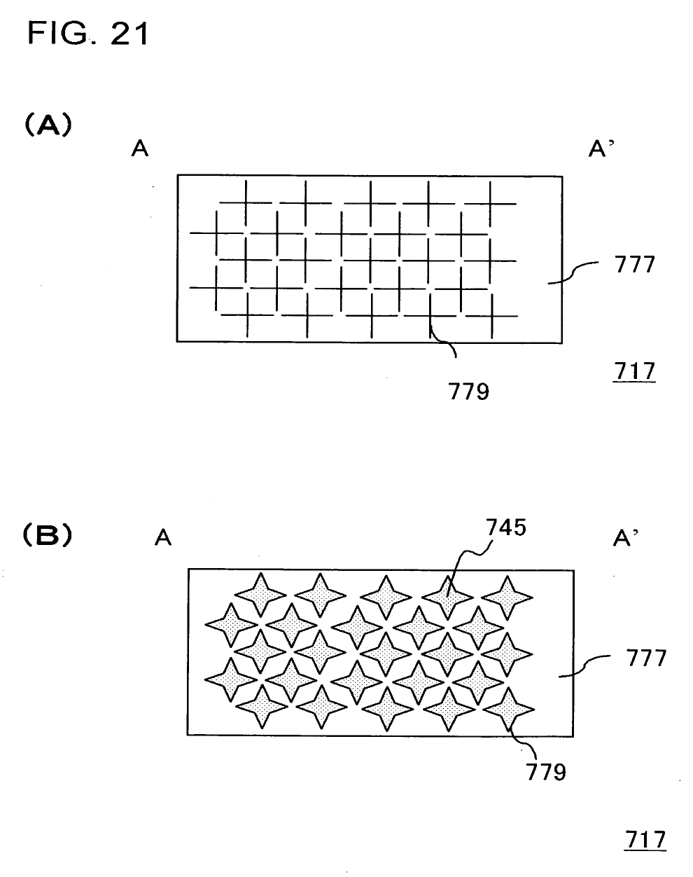

In the fuel cell according to the first to third embodiments, the permeation control film 717 includes an elastic sheet according to this embodiment. FIGS. 21A and 21B are top views showing the structure of the permeation control film 717 provided at the boundary between the fuel vessel 713 and the high-concentration fuel vessel 715.

The permeation control film 717 shown in FIGS. 21A and 21B includes a laminated film of an elastic sheet 777 and a fuel permeable film 745. The elastic sheet 777 has a cut 779, which is opened by pulling the sheet 777 in the horizontal direction to the sheet as shown in the drawing. Using the elastic sheet 777 as the permeation control film 717, the opening area of the cut 779 can be adjusted by modulating the strength of pulling the elastic sheet 777 in its plane direction. Thus, the transmission of the high-concentration fuel 725 from the high-concentration fuel vessel 715 to the fuel vessel 713 can be controlled.

### SIXTEENTH EMBODIMENT

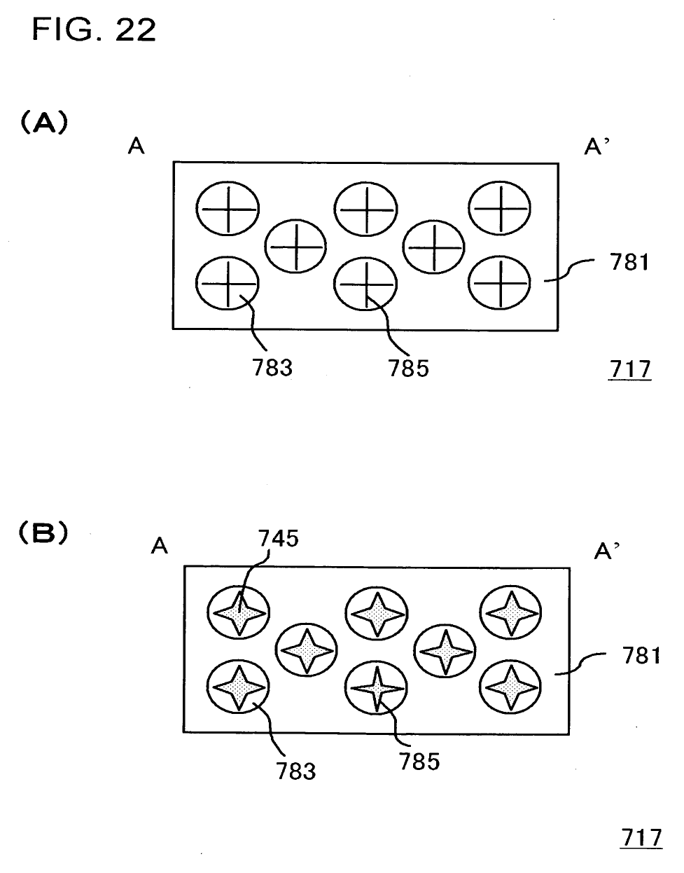

In the fuel cell according to the first to third embodiments, the permeation control film 717 is formed of a sheet having a part that shrinks when current is run through it, according to this embodiment. FIGS. 22A and 22B are top views showing the structure of the permeation control film 717 provided at the boundary between the fuel vessel 713 and the high-concentration fuel vessel 715.

The permeation control film 717 as shown in FIGS. 22A and 22B includes a laminated film of a sheet 781 and a fuel permeable film 745. An elastic part 783 is formed on a part of the sheet. The elastic part 783 has a cut 785. The elastic part 783 shrinks when current is run through it, and thus the opening area of the cut 785 is increased by the shrinkage.

Elastic members made of a material shrinkable by current application, such as an artificial muscle, or made of a polymer having a skeleton of a material shrinkable by current application may be used for the elastic part.

Using the sheet 781 of the permeation control film 717, the opening area of the elastic part 783 can be adjusted by modulating the current value being applied to the sheet 781. Thus, the transmission of the high-concentration fuel 725 from the high-concentration fuel vessel 715 to the fuel vessel 713 can be controlled.

### SEVENTEENTH EMBODIMENT

According to this embodiment, the fuel cell according to the above embodiments further includes a sensor that detects the concentration of the fuel component in the fuel vessel 713 that constitutes the unit cell structure 101. With the sensor, the concentration of the fuel component in the fuel vessel 713 or in the fuel passage 719 can be feedback-controlled based on the detected concentration of the fuel component in the fuel vessel 713. In this embodiment, the fuel component is methanol, and a case where an aqueous methanol solution is supplied as the fuel 124 is described below as an example.

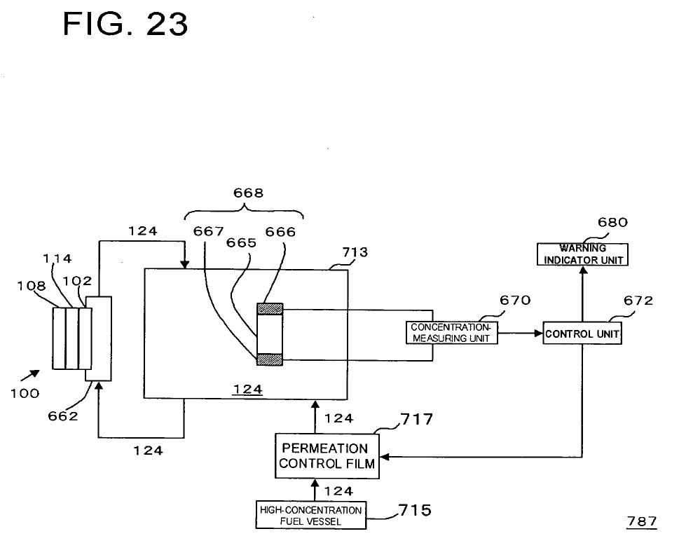

FIG. 23 is a diagram showing an example of the configuration of the fuel cell system according to this embodiment. Referring to FIG. 23, a fuel cell system 787 includes a fuel cell main body 100, a sensor 668, a concentration-measuring unit 670, a control unit 672, a permeation control film 717, and a warning indicator unit 680. The fuel cell main body 100 may be the fuel cell according to the above embodiments. In particular, the fuel cell in which the permeation control film 717 has the shutter is preferably used, because the opening and closing of the shutter can be properly controlled depending on the concentration of the fuel component in the fuel vessel 713. These fuel cells have the unit cell structures 101.

The sensor 668 is used to detect the concentration of the fuel component in the fuel 124 contained in the fuel vessel 713. The sensor 668 includes a polymer film 665, a first electrode terminal 666, and a second electrode terminal 667. The polymer film 665 has proton conductivity. The polymer film 665 is impregnated with the fuel 124 from the fuel vessel 713 and made of a material that changes its proton conductivity depending on the alcohol concentration of the fuel 124. In the fuel cell system 787 according to this embodiment, the methanol concentration of the fuel 124 in the fuel vessel 713 can be detected based on the change in the proton conductivity of the polymer film 665.

The polymer film 665 may be made of any material that changes its proton conductivity depending on the alcohol concentration of the fuel 124. For example, it may be made of the same material as that for the solid electrolyte membrane 114 of the fuel cell main body 100.

The first and second electrode terminals 666 and 667 are placed apart from each other on the surface of the polymer film 665 or in the polymer film 665, in which the polymer film 665 is made of a material that changes its proton conductivity depending on the alcohol concentration. When current is applied across the first and second electrode terminals 666 and 667 through the polymer film 665, the resistance between the first and second electrode terminals 666 and 667 changes depending on the alcohol concentration of the fuel 124 in the fuel vessel 713 or the fuel passage 719. The concentration-measuring unit 670 measures the alcohol concentration of the fuel 124 in the fuel vessel 713 based on the resistance between the first and second electrode terminals 666 and 667. The configuration of the concentration-measuring unit 670 is described in detail later.

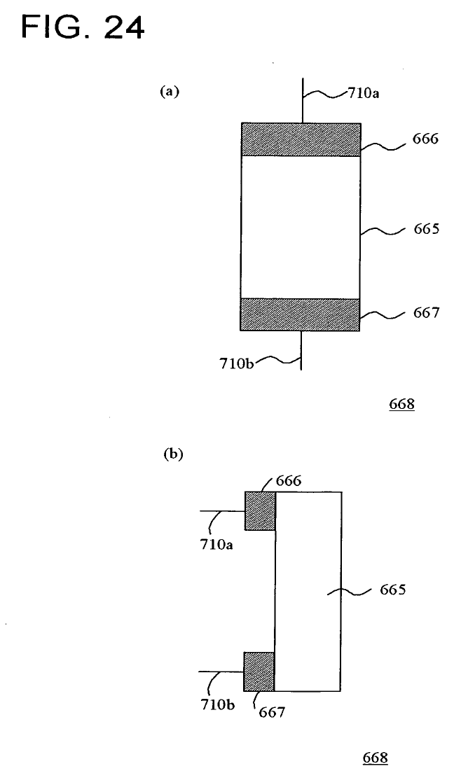

FIGS. 24 are diagrams showing a detail of the sensor 668. FIG. 24(a) is a diagram showing a face where the first and second electrode terminals 666 and 667 of the sensor 668 are provided. FIG. 24(b) is a side view of FIG. 24(a). The first and second electrode terminals 666 and 667 may be made of any material that is stable in the fuel 124 and has electrical conductivity. The first and second electrode terminals 666 and 667 may be attached to the polymer film 665 with an electrically-conductive paste. The electrically-conductive paste may be a polymer paste containing metal such as gold and silver or a polymer paste of an electrically-conductive polymer such as an acrylamide polymer. The first and second electrode terminals 666 and 667 are electrically connected to the concentration-measuring unit 670 as shown in FIG. 23 via wirings 710a and 710b, respectively.

Referring to FIG. 23, the alcohol concentration of the fuel 124 in the fuel vessel 713, which is measured by the concentration-measuring unit 670, is transmitted to the control unit 672. The control unit 672 determines whether the alcohol concentration measured by the concentration-measuring unit 670 is within a proper range or not and controls the permeation control film 717 such that the alcohol concentration of the fuel 124 in the fuel vessel 713 is kept within the proper range. The permeation control film 717 controls the amount of the fuel 124 supplied from the high-concentration fuel vessel 715 to the fuel vessel 713 based on the control by the control unit 672. Specifically, for example, in a case where the permeation control film 717 has the shutter, electric signals or the like may be used to control the opening and closing of the shutter.

The control unit 672 allows the warning indicator 680 to give a warning if the alcohol concentration of the fuel 124 in the fuel vessel 713 is not within the proper range even after the process of controlling the permeation control film 717 is repeated.

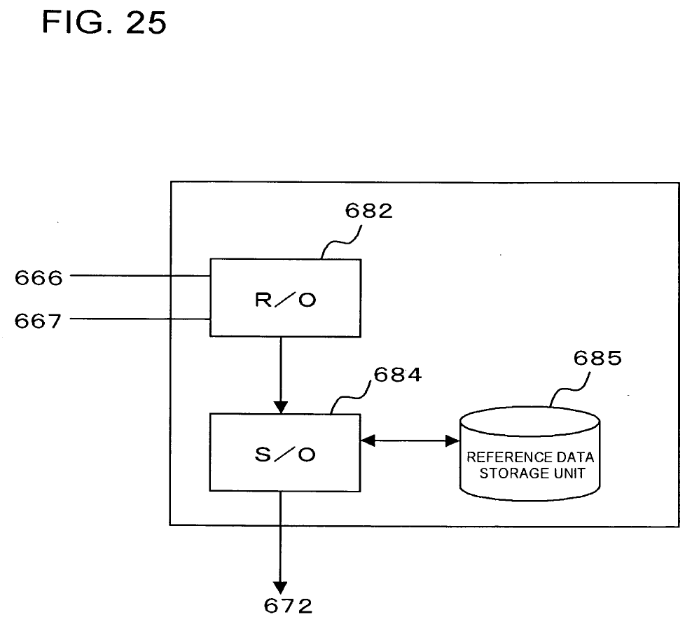

FIG. 25 is a diagram showing a detail of the structure of the concentration-measuring unit 670. The concentration-measuring unit 670 includes a resistance-measuring unit (R/O) 682 that measures the resistance between the first and second electrode terminals 666 and 667, a concentration-calculating unit (S/O) 684 that calculates the alcohol concentration in the fuel vessel 713 based on the resistance measured by the resistance-measuring unit 682, and a reference data storage unit 685 that stores reference data indicating the relationship between the methanol concentration and the resistance between the first and second electrode terminals 666 and 667. The resistance-measuring unit 682 may be an alternating current impedance meter having a bridge circuit. The resistance between the first and second electrode terminals 666 and 667 may be measured using an alternating current with a low amplitude of 20 mV or less. The concentration-calculating unit 684 calculates a methanol concentration from the resistance measured by the resistance-measuring unit 682 based on the reference data from the reference data storage unit 685.

In the fuel cell system 787 according to this embodiment, the alcohol concentration in the fuel vessel 713 is detected with a simple structure in which the first and second electrode terminals 666 and 667 are only attached to the polymer film 665. Particularly in the structure having the shutter-equipped permeation control film 717, therefore, the opening and closing movement of the shutter can be precisely controlled.

The structure of the fuel cell system according to this embodiment may also be used in the structure according to the second embodiment having the permeation control film 717 placed between the fuel passage 719 and the high-concentration fuel vessel 715.

A certain region of the solid electrolyte membrane 114 constituting the unit cell structure 101, where neither the fuel electrode side catalyst layer 106 nor the oxidant electrode side catalyst layer 112 is provided, may be used in place of the polymer film 665. In this case, the fuel component concentration in the solid electrolyte membrane 114 of the unit cell structure 101 may be directly detected for the control of the concentration of the fuel 124.

### EIGHTEENTH EMBODIMENT

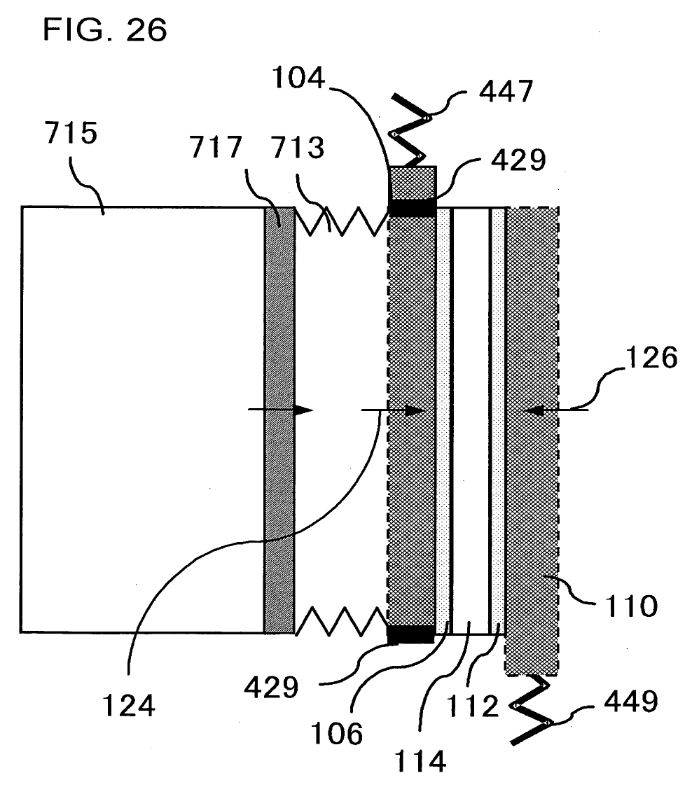

In the fuel supply system of the fuel cell or the fuel cell system according to the above embodiments, the internal pressure can increase over time of cell operation, because of the production of a gas such as carbon dioxide. Thus, the fuel vessel 713 may be configured such that the pressure in it is variable. FIG. 26 is a diagram showing a structure of the fuel cell according to this embodiment. In the structure shown in FIG. 26, a fuel vessel 713 is configured to have a bellows side wall in the fuel cell of FIG. 6. As shown in the drawing, the fuel vessel 713 is in the form of a bag having a variable volume. As the internal pressure of the fuel vessel 713 increases, therefore, the fuel vessel 713 allows the bellows to expand so as to have an increased volume, so that a stoppage in the supply of the high-concentration fuel 725 from the high-concentration fuel vessel 715, due to an increase in the internal pressure of the fuel vessel 713, can be prevented.

Alternatively, the fuel cell as shown in FIG. 26 may include a plastic bag-shaped fuel vessel 713 so as to have a variable volume. The fuel vessel 713 may also have a vent valve for preventing an increase in internal pressure.

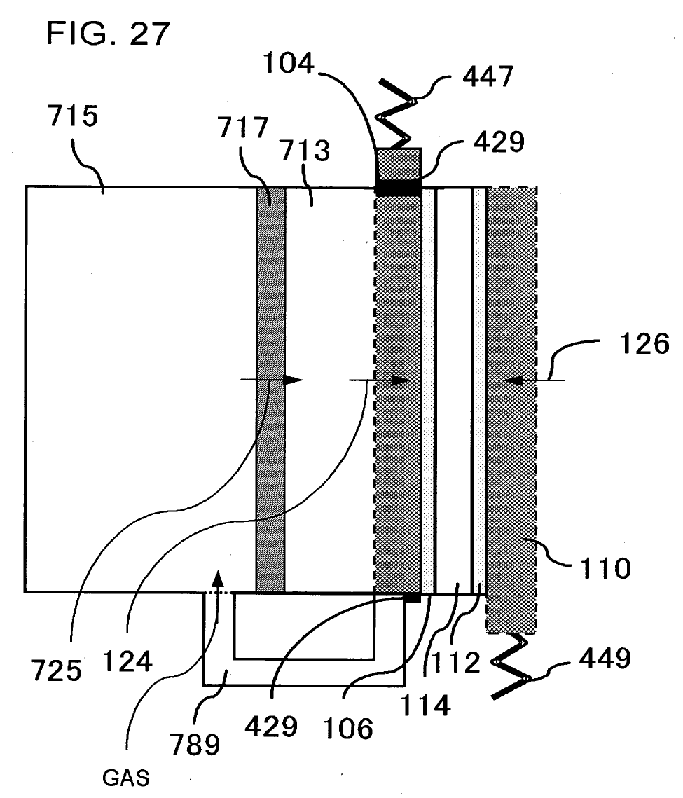

FIG. 27 is a diagram showing another structure of the fuel cell according to this embodiment. Referring to FIG. 27, the fuel cell as shown in FIG. 6 further includes a gas duct 789 through which carbon dioxide produced at the fuel electrode 102 is guided to the high-concentration fuel vessel 715. In such a structure, the internal pressure of the high-concentration fuel vessel 715 can be increased using the pressure of the gas produced at the fuel electrode 102, which further ensures the supply of the high-concentration fuel 725 from the high-concentration fuel vessel 715 to the fuel vessel 713.

While this embodiment is described with reference to the case of the fuel cell of FIG. 6 as an example, this embodiment may also be employed in any of the other structures of the fuel cell or the fuel cell system as described above.

The invention is described above according to the embodiments. These embodiments are illustrative and it should be apparent to those having ordinary skill in the art that modifications and alterations of each constitutes and any combinations of the above processes are possible within the scope of the invention.

For example, the process of controlling the fuel component concentration of the fuel 124 in the fuel vessel 713 or the fuel passage 719 may includes preliminarily monitoring the time period of operation of the fuel cell and the concentration of the fuel component in fuel vessel 713 or the fuel passage 719 and controlling the transmission of the high-concentration fuel 725 through the permeation control film 717, specifically controlling the movement such as the opening and closing of the shutter, based on the monitored data. According to such a structure, control unit is not required to provide and further compact and lightweight fuel cells can be realized.

The system that supplies the high-concentration fuel 725 by the high-concentration fuel vessel 715 and the permeation control film 717 to the fuel vessel 713 may be provided in combination with an apparatus that supplies water or methanol at any appropriate concentration. The combined apparatus supplies water or methanol by means of a pump or by drip method or the like. Accordingly the amount can be adjusted to a proper amount even when the amount of the fuel 124 in the fuel vessel 713 is decreased due to volatilization or the like. Thus, the controllability can be improved with respect to the concentration of the fuel 124.

### EXAMPLE

In this example, a fuel cell having the structure of FIG. 6 was prepared and evaluated for change in cell voltage over time. In the fuel cell with the structure of FIG. 6, the fuel vessel 713 was filled with 60 ml of an aqueous 10% by volume methanol solution, while the high-concentration fuel vessel 715 was filled with an aqueous 50% by volume methanol solution. The permeation control film 717 was in the form of the permeation control shutter 735 composed of a stainless metal mesh coated with Nafion (registered trademark). The permeation control film 735 had a thickness of 500 μm in a dry state. The permeation control film 735 was attached to a Nafion 177 film serving as the fuel permeable film 745. The aqueous methanol solution was supplied from the fuel vessel 713 at a rate of 15 ml/min, while the same test was conducted as in the example. Oxygen in air was used for the oxidant electrode 108.

The catalyst of the fuel cell unit was platinum/ruthenium for the fuel electrode and platinum for the oxidant electrode. Constituent material of the solid electrolyte membrane was Nafion (registered trademark).

### COMPARATIVE EXAMPLE

A fuel cell was prepared using the structure of the example except that neither the high-concentration fuel vessel 715 nor the permeation control film 717 was provided. The fuel vessel 713 was filled with 60 ml of an aqueous 10% by volume methanol solution, which was supplied at a rate of 15 ml/min, when the change in cell voltage over time was evaluated in the same manner as in the example.

Evaluation

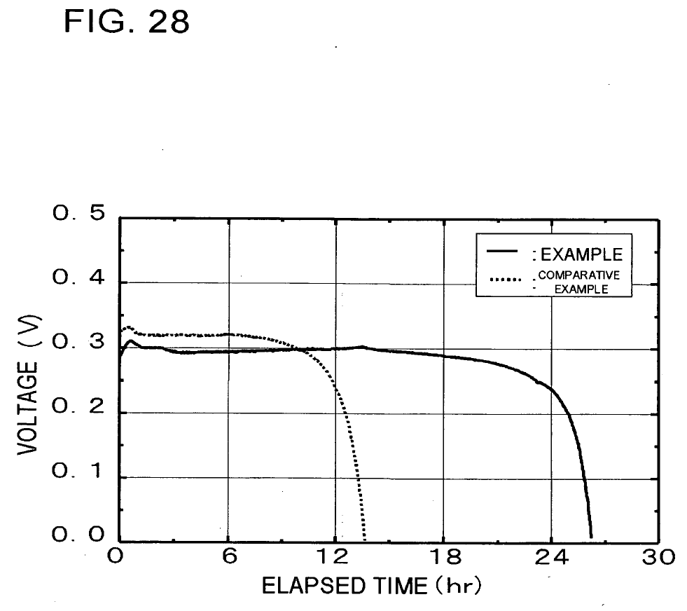

FIG. 28 is a graph showing the relationship between the time period of operation of the fuel cell and the cell voltage. As shown in FIG. 28, it has been demonstrated that the fuel cell of the example with a double tank suppresses the reduction in cell voltage during operation and produces a stable output for an extended period of time in contrast to the fuel cell of the comparative example. This should be because the permeation control film 735 provided at the boundary between the high-concentration fuel vessel 715 and the fuel vessel 713 properly suppresses the reduction in the concentration of the fuel component in the fuel 124 being supplied from the fuel vessel 713.

1. A fuel supplier placed in a fuel supply system of a fuel cell, comprising:
a fuel vessel; and
a permeation control film through which a supplementary fuel contained in said fuel vessel is restrictively transmitted, wherein said supplementary fuel is allowed to move to said fuel supply system through said permeation control film.

2. The fuel supplier as claimed in claim 1,
wherein said permeation control film restricts the amount of transmission of said supplementary fuel based on the fuel concentration of a liquid fuel in said fuel supply system.

3. The fuel supplier as claimed in claim 1,
wherein said permeation control film changes its shape depending on the concentration of said liquid fuel such that the amount of transmission of said supplementary fuel is changed.

4. The fuel supplier as claimed in claim 3,
wherein said film shrinks and expands depending on the concentration of said liquid fuel so as to change its open area ratio.

5. The fuel supplier as claimed in claim 1,
wherein said permeation control film comprises a fuel permeable film that transmits said supplementary fuel and a shutter member that is placed on said fuel permeable film and controls an exposed area of said fuel permeable film.

6. The fuel supplier as claimed in claim 5,
wherein said shutter member restricts the amount of transmission of said supplementary fuel based on the fuel concentration of said liquid fuel in said fuel supply system.

7. The fuel supplier as claimed in claim 5,
wherein said shutter member includes an elastic film having a cut portion, and a surface of said elastic film is allowed to expand and contract such that the cut portion changes its shape and that the exposed area of said fuel permeable film is controlled.

8. The fuel supplier as claimed in claim 5, further comprising a shutter control member that allows said shutter member to slide on the surface of said fuel permeable film such that the exposed area of said fuel permeable film is controlled.

9. The fuel supplier as claimed in claim 5, wherein said fuel permeable film restricts the amount of transmission of said liquid fuel based on the fuel concentration of said liquid fuel in said fuel supply system.

10. The fuel supplier as claimed in claim 1, further comprising a fuel supply unit that is placed adjacent to said fuel vessel through said permeation control film and configured so as to change its volume depending on its internal pressure.

11. A fuel cell, comprising:
a solid electrolyte membrane;
a fuel electrode and an oxidant electrode placed on said solid electrolyte membrane; and
a fuel supply system that supplies a fuel to said fuel electrode,
wherein said fuel supply system has the fuel supplier as claimed in claim 1.

12. The fuel cell as claimed in claim 11, further comprising a gas duct through which a gas produced at said fuel electrode is guided to said fuel vessel.
